(19) United States
(12) Patent Application Publication
(10) Pub. No.: US 2022/0411319 A1
(43) Pub. Date: Dec. 29, 2022

(54) PRECURSOR GLASSES AND TRANSPARENT GLASS-CERAMIC ARTICLES FORMED THEREFROM AND HAVING IMPROVED MECHANICAL DURABILITY

(71) Applicant: CORNING INCORPORATED, CORNING, NY (US)

(72) Inventors: George Halsey Beall, Big Flats, NY (US); Qiang Fu, Painted Post, NY (US); Charlene Marie Smith, Corning, NY (US); Alana Marie Whittier, Painted Post, NY (US)

(21) Appl. No.: 17/841,757

(22) Filed: Jun. 16, 2022

Related U.S. Application Data
(60) Provisional application No. 63/212,145, filed on Jun. 18, 2021.

(51) Int. Cl. C03C 10/00

(52) U.S. Cl. CPC C03C 10/0027; C03C 2204/00; C03C 2203/52

(57) ABSTRACT

A glass-ceramic article includes from 60 mol % to 72 mol % SiO2; from 2.5 mol % to 8 mol % Al₂O₃; from 17 mol % to 26 mol % Li₂O; from 0.2 mol % to 4 mol % ZrO₂; and from 0.5 mol % to 2 mol % P₂O₅. The sum of alkaline earth oxides and transitional metal oxides in the glass-ceramic article may be from 0.1 mol % to 6 mol %, wherein alkaline earth oxides is the sum of CaO, MgO, SrO, and BaO and transition metal oxides is the sum of La₂O₃, Y₂O₃, Ta₂O₅, and GeO₂. The sum of P₂O₅ and ZrO₂ in the glass-ceramic article may be from 1 mol % to 6 mol %. The glass-ceramic article may comprise a crystalline phase comprising lithium disilicate and petalite. The total amount of lithium disilicate and petalite in the crystalline phase of the glass-ceramic article may be greater than 50 wt %, based on a total weight of the crystalline phase.

This application claims the benefit of priority under 35 U.S.C. § 119 of U.S. Provisional Application Ser. No. 63/212,145 filed on Jun. 18, 2021, the content of which is relied upon and incorporated herein by reference in its entirety.

### FIELD

The present specification relates to precursor glass compositions and glass-ceramic articles and, in particular, to precursor glass compositions and ion exchangeable glass-ceramic articles formed therefrom.

### TECHNICAL BACKGROUND

Glass articles, such as cover glasses, glass backplanes, housings, and the like, are employed in both consumer and commercial electronic devices, such as smart phones, tablets, portable media players, personal computers, and cameras. The mobile nature of these portable devices makes the devices and the glass articles included therein particularly vulnerable to accidental drops on hard surfaces, such as the ground. Moreover, glass articles, such as cover glasses, may include “touch” functionality which necessitates that the glass article be contacted by various objects including a user's fingers and/or stylus devices. Accordingly, the glass articles must be sufficiently robust to endure accidental dropping and regular contact without damage, such as scratching. Indeed, scratches introduced into the surface of the glass article may reduce the strength of the glass article as the scratches may serve as initiation points for cracks leading to catastrophic failure of the glass.

Moreover, the optical characteristics of the glass article, such as the transmittance of the glass article, may be an important consideration when the glass article is incorporated as a cover glass in a portable electronic device.

Accordingly, a need exists for alternative materials which have improved mechanical properties relative to glass while also having optical characteristics similar to glass.

### SUMMARY

According to a first aspect A1, a glass ceramic article may comprise: greater than or equal to 60 mol % and less than or equal to 72 mol % SiO₂; greater than or equal to 2.5 mol % and less than or equal to 8 mol % Al₂O₃; greater than or equal to 17 mol % and less than or equal to 26 mol % Li₂O; greater than or equal to 0.2 mol % and less than or equal to 4 mol % ZrO₂; and greater than or equal to 0.5 mol % and less than or equal to 2 mol % P₂O₅, wherein: alkaline earth oxides+transition metal oxides is greater than or equal to 0.1 mol % and less than or equal to 6 mol %, wherein alkaline earth oxides is the sum of CaO, MgO, SrO, and BaO and transition metal oxides is the sum of La₂O₃, Y₂O₃, Ta₂O₅, and GeO₂; P₂O₅+ZrO₂ is greater than or equal to 1 mol % and less than or equal to 6 mol %; (SiO₂+Al₂O₃)/(P₂O₅+ZrO₂) is greater than or equal to 12 mol % and less than or equal to 34 mol %; and the glass-ceramic article comprises a crystalline phase comprising lithium disilicate and petalite, wherein the total amount of lithium disilicate and petalite is greater than 50 wt %, based on a total weight of the crystalline phase.

A second aspect A2 includes the glass-ceramic article according to the first aspect A1, wherein the glass-ceramic article comprises greater than or equal to 0.5 mol % and less than or equal to 4 mol % ZrO₂.

A third aspect A3 includes the glass-ceramic article according to the first aspect A1 or the second aspect A2, wherein alkaline earth oxides+transition metal oxides is greater than or equal to 0.1 mol % and less than or equal to 5 mol %.

A fourth aspect A4 includes the glass-ceramic article according to any one of the first through the third aspects A1-A3, wherein P₂O₅+ZrO₂ is greater than or equal to 2 mol % and less than or equal to 5 mol %.

A fifth aspect A5 includes the glass-ceramic article according to any one of the first through the fourth aspects A1-A4, wherein (SiO₂+Al₂O₃)/(P₂O₅+ZrO₂) is greater than or equal to 14 mol % and less than or equal to 32 mol %.

A sixth aspect A6 includes the glass-ceramic article according to any one of the first through the fifth aspects A1-A5, wherein a molar ratio of Li₂O to Al₂O₃ is greater than or equal to 2 and less than or equal to 12.

A seventh aspect A7 includes the glass-ceramic article according to the sixth aspect A6, wherein a molar ratio of Li₂O to Al₂O₃ is greater than or equal to 4 and less than or equal to 10.

An eighth aspect A8 includes the glass-ceramic article according to any one of the first through the seventh aspects A1-A7, wherein a molar ratio of Li₂O to SiO₂ is greater than or equal to 0.25 and less than or equal to 0.5.

An ninth aspect A9 includes the glass-ceramic article according to the eighth aspect A8, wherein a molar ratio of Li₂O to SiO₂ is greater than or equal to 0.25 and less than or equal to 0.4.

A tenth aspect A10 includes the glass-ceramic article according to any one of the first through the ninth aspects A1-A9, wherein the glass-ceramic article comprises greater than or equal to 2.5 mol % and less than or equal to 6 mol % Al₂O₃.

An eleventh aspect A11 includes the glass-ceramic article according to any one of the first through the tenth aspects A1-A10, wherein the glass-ceramic article comprises greater than or equal to 18 mol % and less than or equal to 24 mol % Li₂O.

A twelfth aspect A12 includes the glass-ceramic article according to any one of the first through the eleventh aspects A1-A11, wherein the glass-ceramic article comprises greater than or equal to 0.7 mol % and less than or equal to 1.75 mol % P₂O₅.

A thirteenth aspect A13 includes the glass-ceramic article according to any one of the first through the twelfth aspects A1-A12, wherein R₂O is greater than or equal to 17 mol % and less than or equal to 30 mol % and R₂O is the sum of Li₂O, Na₂O, and K₂O.

A fourteenth aspect A14 includes the glass-ceramic article according to any one of the first through the thirteenth aspects A1-A13, wherein the glass-ceramic article comprises: greater than or equal to 0 mol % and less than or equal to 6 mol % Na₂O; and greater than or equal to 0 mol % and less than or equal to 6 mol % K₂O.

A fifteenth aspect A15 includes the glass-ceramic article according to any one of the first through the fourteenth aspects A1-A14, wherein the glass-ceramic article comprises: greater than or equal to 0 mol % and less than or equal to 8 mol % CaO; greater than or equal to 0 mol % and less than or equal to 8 mol % MgO; greater than or equal to 0 mol % and less than or equal to 8 mol % SrO; and greater than or equal to 0 mol % and less than or equal to 8 mol % BaO.

A sixteenth aspect A16 includes the glass-ceramic article according to any one of the first through the fifteenth aspects A1-A15, wherein the glass-ceramic article comprises: greater than or equal to 0 mol % and less than or equal to 4 mol % La₂O₃; greater than or equal to 0 mol % and less than or equal to 6 mol % Y₂O₃; greater than or equal to 0 mol % and less than or equal to 3 mol % Ta₂O₅; and greater than or equal to 0 mol % and less than or equal to 2 mol % GeO₂.

A seventeenth aspect A17 includes the glass-ceramic article according to any one of the first through the sixteenth aspects A1-A16, wherein the glass-ceramic article comprises greater than or equal to 0 mol % and less than or equal to 8 mol % B₂O₃.

An eighteenth aspect A18 includes the glass-ceramic article according to any one of the first through the seventeenth aspects A1-A17, wherein the glass-ceramic article comprises greater than or equal to 0 mol % and less than or equal to 10 mol % ZnO.

A nineteenth aspect A19 includes the glass-ceramic article according to any one of the first through the eighteenth aspects A1-A18, wherein grains of lithium disilicate and petalite of the crystalline phase comprise a grain size greater than or equal to 10 nm and less than or equal to 100 nm.

A twentieth aspect A20 includes the glass-ceramic article according to any one of the first through the nineteenth aspects A1-A19, wherein the crystalline phase of the glass-ceramic article further comprises lithium metasilicate, β-quartz, cristobalite, or combinations thereof.

A twenty-first aspect A21 includes the glass-ceramic article according to any one of the first through the twentieth aspects A1-A20, wherein an average transmittance of the glass-ceramic article is greater than or equal to 50% and less than or equal to 95% over the wavelength range of 400 nm to 800 nm as measured at an article thickness of 0.8 mm.

A twenty-second aspect A22 includes the glass-ceramic article according to any one of the first through the twenty-first aspects A1-A21, wherein a K_{Ic} fracture toughness of the glass-ceramic article as measured by a chevron notched short bar method is greater than or equal to 1.0 MPa·m^{1/2}.

A twenty-third aspect A23 includes the glass-ceramic article according to the any one of the first through the twenty-second aspects A1-A22, wherein an elastic modulus of the glass-ceramic article is greater than or equal to 90 GPa.

A twenty-fourth aspect A24 includes the glass-ceramic article according to the any one of the first through the twenty-third aspects A1-A23, wherein the glass-ceramic article is chemically strengthened in an ion exchange bath at a temperature greater than or equal to 350° C. to less than or equal to 500° C. for a time period greater than or equal to 2 hours to less than or equal to 24 hours to form an ion exchanged glass-ceramic article.

A twenty-fifth aspect A25 includes the glass-ceramic article according to the twenty-fourth aspect A24, wherein the ion exchange bath comprises KNO₃.

A twenty-sixth aspect A26 includes the glass-ceramic article according to the twenty-fifth aspect A25, wherein the ion exchange bath further comprises NaNO₃.

A twenty-seventh aspect A27 includes the glass-ceramic article according to any one of the twenty-fourth through the twenty-seventh aspects A24-A26, wherein the glass-ceramic article has a maximum central tension greater than or equal to 30 MPa.

A twenty-eighth aspect A28 includes the glass-ceramic article according to any one of the twenty-fourth through the twenty-seventh aspects A24-A27, wherein the glass-ceramic article has a surface compressive stress greater than or equal to 80 MPa.

A twenty-ninth aspect A29 includes the glass-ceramic article according to any one of the twenty-fourth through the twenty-eighth aspects A24-A28, wherein the glass-ceramic article has a depth of compression greater than or equal to 0.025 t.

A thirtieth aspect A30 includes the glass-ceramic article according to any one of the twenty-fourth through the twenty-ninth aspects A24-A29, wherein the glass-ceramic article has a depth of sodium ion penetration greater than or equal to 0.025 t and less than or equal to 0.28 t.

A thirty-first aspect A31 includes the glass-ceramic article according to any one of the twenty-fourth through the thirtieth aspects A24-A30, wherein the glass-ceramic article has a depth of potassium ion penetration greater than or equal to 0 t and less than or equal to 0.01 t.

According to a thirty-second aspect A32, a glass composition may comprise: greater than or equal to 60 mol % and less than or equal to 72 mol % SiO₂; greater than or equal to 2.5 mol % and less than or equal to 8 mol % Al₂O₃; greater than or equal to 2.5 mol % and less than or equal to 8 mol % Al₂O₃; greater than or equal to 1.5 mol % and less than or equal to 4 mol % ZrO₂; and greater than or equal to 0.5 mol % and less than or equal to 2 mol % P₂O₅, wherein: alkaline earth oxides+transition metal oxides is greater than or equal to 0.1 mol % and less than or equal to 6 mol %, wherein alkaline earth oxides is the sum of CaO, MgO, SrO, and BaO and transition metal oxides is the sum of La₂O₃, Y₂O₃, Ta₂O₅, and GeO₂; and P₂O₅+ZrO₂ is greater than or equal to 1 mol % and less than or equal to 6 mol %.

A thirty-third aspect A33 includes the glass composition according to the thirty-second aspect A32, P₂O₅+ZrO₂ is greater than or equal to 1 mol % and less than or equal to 6 mol %.

A thirty-fourth aspect A34 includes the glass composition according to the thirty-second aspect A32 or the thirty-third aspect A33, wherein P₂O₅+ZrO₂ is greater than or equal to 2 mol % and less than or equal to 5 mol %.

A thirty-fifth aspect A35 includes the glass composition according to any of the thirty-second through third-fourth aspects A32-A34, wherein a molar ratio of Li₂O to Al₂O₃ is greater than or equal to 2 and less than or equal to 12.

A thirty-sixth aspect A36 includes the glass composition according to the thirty-fifth aspect A35, wherein a molar ratio of Li₂O to Al₂O₃ is greater than or equal to 4 and less than or equal to 10.

A thirty-seventh aspect A37 includes the glass composition according to any one of the thirty-second through the thirty-sixth aspects A32-A36, wherein a molar ratio of Li₂O to SiO₂ is greater than or equal to 0.25 and less than or equal to 0.5.

A thirty-eigth aspect A38 includes the glass composition according to the thirty-seventh aspect A37, wherein a molar ratio of Li₂O to SiO₂ is greater than or equal to 0.25 and less than or equal to 0.4.

A thirty-ninth aspect A39 includes the glass composition according to any one of the thirty-second through the thirty-eighth aspects A32-A38, wherein the glass composition comprises greater than or equal to 2.5 mol % and less than or equal to 6 mol % Al₂O₃.

A fortieth aspect A40 includes the glass composition according to any one of the thirty-second through the thirty-ninth aspects A32-A39, wherein the glass composition comprises greater than or equal to 18 mol % and less than or equal to 24 mol % Li₂O.

A forty-first aspect A41 includes the glass composition according to any one of the thirty-second through the fortieth aspects A32-A40, wherein the glass composition comprises greater than or equal to 0.7 mol % and less than or equal to 1.75 mol % P₂O₅.

A forty-second aspect A42 includes the glass composition according to any one of the thirty-second through the forty-first aspects A32-A41, wherein R₂O is greater than or equal to 17 mol % and less than or equal to 30 mol % and R₂O is the sum of Li₂O, Na₂O, and K₂O.

A forty-third aspect A43 includes the glass composition according to any one of the thirty-second through the forty-second aspects A32-A42, wherein the glass composition comprises: greater than or equal to 0 mol % and less than or equal to 8 mol % CaO; greater than or equal to 0 mol % and less than or equal to 8 mol % MgO; greater than or equal to 0 mol % and less than or equal to 8 mol % SrO; and greater than or equal to 0 mol % and less than or equal to 8 mol % BaO.

A forty-fourth aspect A44 includes the glass composition according to any one of the thirty-second through the forty-third aspects A32-A43, wherein the glass composition comprises: greater than or equal to 0 mol % and less than or equal to 4 mol % La₂O₃; greater than or equal to 0 mol % and less than or equal to 6 mol % Y₂O₃; greater than or equal to 0 mol % and less than or equal to 3 mol % Ta₂O₅; and greater than or equal to 0 mol % and less than or equal to 2 mol % GeO₂.

A forty-fifth aspect A45 includes the glass composition according to any one of the thirty-second through the forty-fourth aspects A32-A44, wherein the glass composition comprises greater than or equal to 0 mol % and less than or equal to 8 mol % B₂O₃.

A forty-sixth aspect A46 includes the glass composition according to any one of the thirty-second through the forty-fifth aspects A32-A45, wherein the glass composition comprises greater than or equal to 0 mol % and less than or equal to 10 mol % ZnO.

According to a forty-seventh aspect A47, a glass-ceramic article may comprise: heating a precursor glass article in an oven at a rate greater than or equal to 1° C./min and less than or equal to 10° C./min to a nucleation temperature, wherein the precursor glass article comprises a precursor glass composition comprising: greater than or equal to 60 mol % and less than or equal to 72 mol % SiO₂; greater than or equal to 2.5 mol % and less than or equal to 8 mol % Al₂O₃; greater than or equal to 17 mol % and less than or equal to 26 mol % Li₂O; greater than or equal to 0.5 mol % and less than or equal to 4 mol % ZrO₂; and greater than or equal to 0.5 mol % and less than or equal to 2 mol % P₂O₅, wherein: alkaline earth oxides+transition metal oxides is greater than or equal to 0.1 mol % and less than or equal to 6 mol %, wherein alkaline earth oxides is the sum of CaO, MgO, SrO, and BaO and transition metal oxides is the sum of La₂O₃, Y₂O₃, Ta₂O₅, and GeO₂; P₂O₅+ZrO₂ is greater than or equal to 1 mol % and less than or equal to 6 mol %; and (SiO₂+Al₂O₃)/(P₂O₅+ZrO₂) is greater than or equal to 12 mol % and less than or equal to 34 mol %; maintaining the precursor glass article at the nucleation temperature in the oven for time greater than or equal to 0.1 hour and less than or equal to 8 hours to produce a nucleated crystallizable glass; heating the nucleated crystallizable glass article in the oven at a rate greater than or equal to 1° C./min and less than or equal to 10° C./min to a crystallization temperature; maintaining the nucleated crystallizable glass article at the crystallization temperature in the oven for a time greater than or equal to 0.1 hour and less than or equal to 8 hours to produce the glass-ceramic article, wherein the glass-ceramic article comprises a crystalline phase comprising lithium disilicate and petalite, wherein the total amount of lithium disilicate and petalite is greater than 50 wt %, based on a total weight of the crystalline phase; and cooling the glass-ceramic article to room temperature.

A forty-eighth aspect A48 includes the glass-ceramic article according to the forty-seventh aspect A47, wherein an average transmittance of the glass-ceramic article is greater than or equal to 50% and less than or equal to 95% over the wavelength range of 400 nm to 800 nm as measured at an article thickness of 0.8 mm.

A forty-ninth aspect A49 includes the glass-ceramic article according to any one of the forty-seventh aspect A47 or the forty-eighth aspect A48, wherein a K_{Ic} fracture toughness of the glass-ceramic article as measured by a chevron notched short bar method is greater than or equal to 1.0 MPa·m^{1/2}.

A fiftieth aspect A50 includes the glass-ceramic article according to any of the forty-seventh through the forty-ninth aspects A47-A49, wherein an elastic modulus of the glass-ceramic article is greater than or equal to 90 GPa.

A fifty-first aspect A51 includes the glass-ceramic article according to any of the forty-seventh through the fiftieth aspects A47-A50, further comprising strengthening the glass-ceramic article in an ion exchange bath at a temperature greater than or equal to 350° C. to less than or equal to 500° C. for a time period greater than or equal to 2 hours to less than or equal to 12 hours to form an ion exchanged glass-ceramic article.

A fifty-second aspect A52 includes the glass-ceramic article according to the fifty-first aspect A51, wherein the ion exchange bath comprises KNO₃.

A fifty-third aspect A53 includes the glass-ceramic article according to the fifty-second aspect A52, wherein the ion exchange bath further comprises NaNO₃.

A fifty-fourth aspect A54 includes the glass-ceramic article according to any of the fifty-first through the fifty-third aspects A51-A53, wherein the glass-ceramic article has a maximum central tension greater than or equal to 30 MPa.

A fifty-fifth aspect A55 includes the glass-ceramic article according to any of the fifty-first through the fifty-fourth aspects A51-A54, wherein the glass-ceramic article has a surface compressive stress greater than or equal to 80 MPa.

A fifty-sixth aspect A56 includes the glass-ceramic article according to any of the fifty-first through the fifty-fifth aspects A51-A55, wherein the glass-ceramic article has a depth of compression greater than or equal to 0.025 t.

A fifty-seventh aspect A57 includes the glass-ceramic article according to any of the fifty-first through the fifty-sixth aspects A51-A56, wherein the glass-ceramic article has a depth of sodium ion penetration greater than or equal to 0.025 t and less than or equal to 0.28 t.

A fifty-eighth aspect A58 includes the glass-ceramic article according to any of the fifty-first through the fifty-seventh aspects A51-A57, wherein the glass-ceramic article has a depth of potassium ion penetration greater than or equal to 0 t and less than or equal to 0.01 t.

According to a fifty-ninth aspect A59, a consumer electronic device may comprise: a housing having a front surface, a back surface, and side surfaces; electrical components provided at least partially within the housing, the electrical components including at least a controller, a memory, and a display, the display being provided at or adjacent the front surface of the housing; and the glass-ceramic article of the first aspect A1 at least one of disposed over the display and forming a portion of the housing.

Additional features and advantages of the glass-ceramic articles described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is a plan view of an electronic device incorporating any of the glass-ceramic articles according to one or more embodiments described herein;

FIG. 2 is a perspective view of the electronic device of FIG. 1;

FIG. 3 is a plot of central tension (x-axis: ion exchange time; y-axis: central tension) of a comparative glass-ceramic article made from a comparative glass composition and example glass-ceramic articles made from precursor glass compositions according to one or more embodiments described herein;

FIG. 4 is a plot of central tension (x-axis: ion exchange time; y-axis: central tension) of a comparative glass-ceramic article made from a comparative glass composition and an example glass-ceramic article made from a precursor glass composition according to one or more embodiments described herein; and

FIG. 5 is a plot of central tension (x-axis: ion exchange time; y-axis: central tension) of a comparative glass-ceramic article made from a comparative glass composition and an example glass-ceramic article made from a precursor glass composition according to one or more embodiments described herein.

### DETAILED DESCRIPTION

Reference will now be made in detail to various embodiments of precursor glass compositions and glass-ceramic articles formed therefrom having improved mechanical durability. According to embodiments, a glass-ceramic article includes greater than or equal to 60 mol % and less than or equal to 72 mol % SiO₂; greater than or equal to 2.5 mol % and less than or equal to 8 mol % Al₂O₃; greater than or equal to 17 mol % and less than or equal to 26 mol % Li₂O; greater than or equal to 0.2 mol % and less than or equal to 4 mol % ZrO₂; and greater than or equal to 0.5 mol % and less than or equal to 2 mol % P₂O₅. The sum of alkaline earth oxides and transitional metal oxides in the glass-ceramic article may be greater than or equal to 0.1 mol % and less than or equal to 6 mol %, wherein alkaline earth oxides is the sum of CaO, MgO, SrO, and BaO and transition metal oxides is the sum of La₂O₃, Y₂O₃, Ta₂O₅, and GeO₂. The sum of P₂O₅ and ZrO₂ in the glass-ceramic article may be greater than or equal to 1 mol % and less than or equal to 6 mol %. The glass-ceramic article may comprise a crystalline phase comprising lithium disilicate and petalite. The total amount of lithium disilicate and petalite in the crystalline phase of the glass-ceramic article may be greater than 50 wt %, based on a total weight of the crystalline phase. Various embodiments of precursor glass compositions and methods of forming ion exchangeable glass-ceramic articles therefrom will be referred to herein with specific reference to the appended drawings.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

The term “substantially free,” when used to describe the concentration and/or absence of a particular constituent component in a precursor glass composition and the resultant glass-ceramic article, means that the constituent component is not intentionally added to the precursor glass composition and the resultant glass-ceramic article. However, the precursor glass composition and the resultant glass-ceramic article may contain traces of the constituent component as a contaminant or tramp in amounts of less than 0.1 mol %.

The terms “0 mol %” and “free,” when used to describe the concentration and/or absence of a particular constituent component in a precursor glass composition and the resultant glass-ceramic article, means that the constituent component is not present in the precursor glass composition and the resultant glass-ceramic article.

In embodiments of the precursor glass compositions and the resultant glass-ceramic articles described herein, the concentrations of constituent components (e.g., SiO₂, Al₂O₃, and the like) are specified in mole percent (mol %) on an oxide basis, unless otherwise specified.

The term “fracture toughness (K_{IC}),” as used herein, represents the ability of a glass composition to resist fracture. Fracture toughness is measured on a non-strengthened glass article, such as measuring the K_{IC} value prior to ion exchange (IOX) treatment of the glass article, thereby representing a feature of a glass substrate prior to IOX. The fracture toughness test methods described herein are not suitable for glasses that have been exposed to IOX treatment. But, fracture toughness measurements performed as described herein on the same glass prior to IOX treatment (e.g., glass substrates) correlate to fracture toughness after IOX treatment, and are accordingly used as such. The chevron notched short bar (CNSB) method utilized to measure the K_{IC} value is disclosed in Reddy, K. P. R. et al, “Fracture Toughness Measurement of Glass and Ceramic Materials Using Chevron-Notched Specimens,” J. Am. Ceram. Soc., 71 [6], C-310-C-313 (1988) except that Y*ₘ is calculated using equation 5 of Bubsey, R. T. et al., “Closed-Form Expressions for Crack-Mouth Displacement and Stress Intensity Factors for Chevron-Notched Short Bar and Short Rod Specimens Based on Experimental Compliance Measurements,” NASA Technical Memorandum 83796, pp. 1-30 (October 1992). The double torsion method and fixture utilized to measure the K_{IC} value is described in Shyam, A. and Lara-Curzio, E., “The double-torsion testing technique for determination of fracture toughness and slow crack growth of materials: A review,” J. Mater. Sci., 41, pp. 4093-4104, (2006). The double torsion measurement method generally produces K_{IC} values that are slightly higher than the chevron notched short bar method. Unless otherwise specified, all fracture toughness values were measured by chevron notched short bar (CNSB) method.

Transmittance data (total transmittance and diffuse transmittance) was measured with a Lambda 950 UV/Vis Spectrophotometer manufactured by PerkinElmer Inc. (Waltham, Massachusetts USA). The Lambda 950 apparatus was fitted with a 150 mm integrating sphere. Data was collected using an open beam baseline and a Spectralon® reference reflectance disk. For total transmittance (Total Tx), the sample is fixed at the integrating sphere entry point. For diffuse transmittance (Diffuse Tx), the Spectralon® reference reflectance disk over the sphere exit port is removed to allow on-axis light to exit the sphere and enter a light trap. A zero offset measurement is made, with no sample, of the diffuse portion to determine efficiency of the light trap. To correct diffuse transmittance measurements, the zero offset contribution is subtracted from the sample measurement using the equation: Diffuse Tx=Diffuse_{Measured}−(Zero Offset*(Total Tx/100)). The scatter ratio is measured for all wavelengths as: (% Diffuse Tx/% Total Tx).

The term “average transmittance,” as used herein, refers to the average of transmittance measurements made within a given wavelength range with each whole numbered wavelength weighted equally. In embodiments described herein, the “average transmittance” is reported over the wavelength range from 400 nm to 800 nm (inclusive of endpoints).

The term “transparent,” when used to describe a glass-ceramic article formed of a precursor glass composition described herein, means that the glass-ceramic article has an average transmittance of greater than or equal to 85% when measured at normal incidence for light in a wavelength range from 400 nm to 800 nm (inclusive of endpoints) at an article thickness of 0.8 mm.

The term “transparent haze,” when used to describe a glass-ceramic article formed of a precursor glass composition described herein, means that the glass-ceramic article has an average transmittance of greater than or equal to 50% and less than 85% when measured at normal incidence for light in a wavelength range from 400 nm to 800 nm (inclusive of endpoints) at an article thickness of 0.8 mm.

The term “translucent,” when used to describe a glass-ceramic article formed of a precursor glass composition described herein, means that the glass-ceramic article has an average transmittance greater than or equal to 20% and less than 50% when measured at normal incidence for light in a wavelength range from 400 nm to 800 nm (inclusive of endpoints) at an article thickness of 0.8 mm.

The term “opaque,” when used to describe a glass-ceramic article formed of precursor glass composition described herein, means that the glass-ceramic article has an average transmittance less than 20% when measured at normal incidence for light in a wavelength range from 400 nm to 800 nm (inclusive of endpoints) at an article thickness of 0.8 mm.

The term “melting point,” as used herein, refers to the temperature at which the viscosity of the precursor glass composition is 200 poise.

The term “softening point,” as used herein, refers to the temperature at which the viscosity of the precursor glass composition is 1×10⁷⁶ poise. The softening point is measured according to the parallel plate viscosity method which measures the viscosity of inorganic glass from 10⁷ to 10⁹ poise as a function of temperature, similar to ASTM C1351M.

The term “liquidus viscosity,” as used herein, refers to the viscosity of the precursor glass composition at the onset of devitrification (i.e., at the liquidus temperature as determined with the gradient furnace method according to ASTM C829-81).

The term “liquidus temperature,” as used herein, refers to the temperature at which the precursor glass composition begins to devitrify as determined with the gradient furnace method according to ASTM C829-81.

The elastic modulus (also referred to as Young's modulus) of the glass-ceramic article, as described herein, is provided in units of gigapascals (GPa) and is measured in accordance with ASTM C623.

The shear modulus of the glass-ceramic article, as described herein, is provided in units of gigapascals (GPa) and is measured in accordance with ASTM C623.

Poisson's ratio, as described herein, is measured in accordance with ASTM C623.

The term “linear coefficient of thermal expansion” and “CTE,” as described herein, is measured in accordance with ASTM E228-85 over the temperature range of 25° C. to 300° C. and is expressed in terms of “×10⁻⁷/° C.”

Surface compressive stress is measured with a surface stress meter (FSM) such as commercially available instruments such as the FSM-6000, manufactured by Orihara Industrial Co., Ltd. (Japan). Surface stress measurements rely upon the measurement of the stress optical coefficient (SOC), which is related to the birefringence of the glass-ceramic article. SOC, in turn, is measured according to Procedure C (Glass Disc Method) described in ASTM standard C770-16, entitled “Standard Test Method for Measurement of Glass Stress-Optical Coefficient,” the contents of which are incorporated herein by reference in their entirety. Depth of compression (DOC) is measured with the FSM in conjunction with a scatter light polariscope (SCALP) technique known in the art. FSM measures the depth of compression for potassium ion exchange and SCALP measures the depth of compression for sodium ion exchange. The maximum central tension (CT) values are measured using a SCALP technique known in the art. The values reported for central tension (CT) herein refer to the maximum central tension unless otherwise indicated.

The terms “depth of compression” and “DOC” refer to the position in the glass-ceramic article where compressive stress transitions to tensile stress.

The term “depth of sodium ion penetration after ion exchange,” as used herein, refers to the depth within the glass-ceramic article (i.e., the distance from a surface of the glass-ceramic article to its interior region) at which a sodium ion introduced by an ion exchange process diffuses into the glass-ceramic article where the concentration of the sodium ion reaches a minimum value, as determined by Glow Discharge-Optical Emission Spectroscopy (GD-OES).

The term “depth of potassium ion penetration after ion exchange,” as used herein, refers to the depth within the glass-ceramic article (i.e., the distance from a surface of the glass-ceramic article to its interior region) at which a potassium ion introduced by an ion exchange process diffuses into the glass-ceramic article where the concentration of the potassium ion reaches a minimum value, as determined by GD-OES.

The term “grain size,” as used herein, refers to the average size of the largest dimension of the grain as measured using scanning electron microscopy as described in M. N. Rahaman, “Ceramic Processing,” CRC Press, 2007, pp. 107.

The term “aspect ratio,” as used herein, refers to the average ratio of the largest dimension and the smallest dimension orthogonal to it in the grain as measured using scanning electron microscopy as described in M. N. Rahaman, “Ceramic Processing,” CRC Press, 2007, pp. 107).

Electron diffraction images using scanning electron microscopy (SEM), as described herein, were taken with a ZEISS Gemini SEM 500 Scanning Electron Microscope at a working distance (WD) of 4.7 mm, an electron high tension (EHT) of 3.00, and high vacuum mode

The term “precursor glass composition,” as used herein, refers to a glass composition which, upon heat treatment, forms a precursor glass article or a glass-ceramic article.

The term “precursor glass article,” as used herein, refers to a glass article containing one or more nucleating agents which, upon heat treatment, causes the nucleation of a crystalline phase.

The term “glass-ceramic article,” as used herein, refers to an article formed from heat treating a glass article formed from a precursor glass composition to induce nucleation of the crystalline phase. In embodiments, the glass-ceramic articles have about 1% to about 99% crystallinity.

For ease of reading, the term “precursor glass composition” is referred to throughout the Detailed Description. However, it should be appreciated that the glass-ceramic articles described herein are produced by heat treating a precursor glass article formed from a precursor glass composition.

Glass-ceramic articles generally have improved fracture toughness relative to articles formed from glass due to the presence of crystalline grains, which impede crack growth, and the relatively high elastic modulus of the glass-ceramic articles. However, because of the microstructure inherent to glass-ceramic articles, it may be difficult to achieve the desired transparency. Moreover, alkali oxides present in the precursor glass composition may be included in the crystalline phase after heat treatment and may not be available for ion exchange.

Disclosed herein are precursor glass compositions and glass-ceramic articles formed therefrom which mitigate the aforementioned problems. Specifically, the precursor glass compositions described herein comprise relatively high concentrations of Li₂O, Al₂O₃, K₂O, P₂O₅, and ZrO₂, resulting in transparent or transparent haze, lithium disilicate and petalite containing glass-ceramic articles having a relatively high amount of Li₂O present in the residual glass phase. Thus, the residual glass phase may be readily ion exchanged. Moreover, the lithium disilicate and petalite nanocrystals have an interlocking microstructure, which may aid in improving the fracture toughness of the glass-ceramic article. “Interlocking microstructure” means elongated and randomly oriented nanocrystals that are engaged and intertwined with each other. This interlocking structure creates a tortuous path for and impedes crack propagation. The Al₂O₃ content as well as the relatively large amount of lithium disilicate and petalite (e.g., greater than 50 wt %, based on a total weight of the crystalline phase) may result in a relatively high elastic modulus compared to articles formed from glass alone. Additionally, the precursor glass compositions described herein comprise alkaline earth oxides (i.e., CaO, MgO, SrO, BaO) and/or transition metal oxides (i.e., La₂O₃, Y₂O₃, Ta₂O₅, and GeO₂), which may largely partition into the residual glass and may result in a glass-ceramic article having relatively high maximum central tension.

The precursor glass compositions and glass-ceramic articles described herein may be described as lithium aluminosilicate precursor glass compositions and glass-ceramic articles and comprise SiO₂, Al₂O₃, and Li₂O. In addition to SiO₂, Al₂O₃, and Li₂O, the precursor glass compositions and glass-ceramic articles described herein further include ZrO₂ and P₂O₅ to achieve crystalline phases including the desired lithium disilicate and petalite phases. The precursor glass compositions and glass-ceramic articles described herein further include alkaline earth oxides (i.e., CaO, MgO, SrO, and BaO) and/or transition metal oxides (i.e., La₂O₃, Y₂O₃, Ta₂O₅, and GeO₂) to increase the maximum central tension of the resulting glass-ceramic articles.

SiO₂ is the primary glass former in the precursor glass compositions described herein and may function to stabilize the network structure of the glass-ceramic articles. The concentration of SiO₂ in the precursor glass compositions should be sufficiently high (e.g., greater than or equal to 60 mol %) to form crystalline phases including lithium disilicate and petalite when the precursor glass composition is subjected to heat treatment to convert the precursor glass composition to a glass-ceramic article. The concentration of SiO₂ may be limited (e.g., less than or equal to 72 mol %) to control the melting point of the precursor glass composition, as the melting temperature of pure SiO₂ or high SiO₂ glasses is undesirably high. Thus, limiting the concentration of SiO₂ may aid in improving the meltability and the formability of the resulting glass-ceramic article.

Accordingly, in embodiments, the precursor glass composition and the resultant glass-ceramic article may comprise greater than or equal to 60 mol % and less than or equal to 72 mol % SiO₂. In embodiments, the concentration of SiO₂ in the precursor glass composition and the resultant glass-ceramic article may be greater than or equal to 60 mol %, greater than or equal to 64 mol %, or even greater than or equal to 66 mol %. In embodiments, the concentration of SiO₂ in the precursor glass composition and the resultant glass-ceramic article may be less than or equal to 72 mol % or even less than or equal to 70 mol %. In embodiments, the concentration of SiO₂ in the precursor glass composition and the resultant glass-ceramic article may be may be greater than or equal to 60 mol % and less than or equal to 72 mol %, greater than or equal to 60 mol % and less than or equal to 70 mol %, greater than or equal to 64 mol % and less than or equal to 72 mol %, greater than or equal to 64 mol % and less than or equal to 70 mol %, greater than or equal to 66 mol % and less than or equal to 72 mol %, or even greater than or equal to 66 mol % and less than or equal to 70 mol %, or any and all sub-ranges formed from any of these endpoints.

Al₂O₃ is a constituent of petalite and is included in the precursor glass compositions described herein to achieve this crystalline phase. Like SiO₂, Al₂O₃ may also stabilize the glass network and additionally provides improved mechanical properties and chemical durability to the resulting glass-ceramic article. The concentration of Al₂O₃ may also be tailored to the control the viscosity of the precursor glass composition. However, if the concentration of Al₂O₃ is too high, the viscosity of the melt may increase and the fraction of lithium disilicate nanocrystals may decrease to an extent that no interlocking structure may be formed. The concentration of Al₂O₃ should be sufficiently high (e.g., greater than or equal to 2.5 mol %) such that the resulting glass-ceramic article has lithium disilicate and has the desired fracture toughness (e.g., greater than or equal to 1.0 MPa·m^{1/2}). However, if the concentration of Al₂O₃ is too high (e.g., greater than 8 mol %), the viscosity of the melt may increase, thereby diminishing the formability of the resulting glass-ceramic article, and the fraction of lithium disilicate nanocrystals may decrease.

In embodiments, the precursor glass composition and the resultant glass-ceramic article may comprise greater than or equal to 2.5 mol % and less than or equal to 8 mol % Al₂O₃. In embodiments, the precursor glass composition and the resultant glass-ceramic article may comprise greater than or equal to 2.5 mol % and less than or equal to 6 mol % Al₂O₃. In embodiments, the concentration of Al₂O₃ in the precursor glass composition and the resultant glass-ceramic article may be greater than or equal to 2.5 mol %, greater than or equal to 3 mol %, or even greater than or equal to 3.5 mol %. In embodiments, the concentration of Al₂O₃ in the precursor glass composition and the resultant glass-ceramic article may be less than or equal to 8 mol %, less than or equal to 6 mol %, or even less than or equal to 4.5 mol %. In embodiments, the concentration of Al₂O₃ in the precursor glass composition and the resultant glass-ceramic article may be greater than or equal to 2.5 mol % and less than or equal to 8 mol %, greater than or equal to 2.5 mol % and less than or equal to 6 mol %, greater than or equal to 2.5 mol % and less than or equal to 4.5 mol %, greater than or equal to 3 mol % and less than or equal to 8 mol %, greater than or equal to 3 mol % and less than or equal to 6 mol %, greater than or equal to 3 mol % and less than or equal to 4.5 mol %, greater than or equal to 3.5 mol % and less than or equal to 8 mol %, greater than or equal to 3.5 mol % and less than or equal to 6 mol %, or even greater than or equal to 3.5 mol % and less than or equal to 4.5 mol %, or any and all sub-ranges formed from any of these endpoints.

Li₂O is a constituent in lithium disilicate and petalite and is included in the precursor glass compositions described herein to achieve these desired phases. Li₂O also aids in the ion exchangeability of the resulting glass-ceramic article. Li₂O reduces the softening point of the precursor glass composition thereby increasing the formability of the resulting glass-ceramic article. The concentration of Li₂O should be sufficiently high (e.g., greater than or equal to 17 mol % such that the resulting glass-ceramic article has lithium disilicate and petalite in an amount greater than or equal to 50 wt %, based on a total weight of the crystalline phase. However, if the concentration of Li₂O is too high (e.g., greater than 26 mol %), the viscosity of the melt may undesirably increase, thereby diminishing the formability of the resulting precursor glass and glass-ceramic article.

Accordingly, in embodiments, the precursor glass composition and the resultant glass-ceramic article may comprise greater than or equal to 17 mol % and less than or equal to 26 mol % Li₂O. In embodiments, the precursor glass composition and the resultant glass-ceramic article may comprise greater than or equal to 18 mol % and less than or equal to 24 mol % Li₂O. In embodiments, the concentration of Li₂O in the precursor glass composition and the resultant glass-ceramic article may be greater than or equal to 17 mol %, greater than or equal to 18 mol %, or even greater than or equal to 20 mol %. In embodiments, the concentration of Li₂O in the precursor glass composition and the resultant glass-ceramic article may be less than or equal to 26 mol %, less than or equal to 24 mol %, or even less than or equal to 22 mol %. In embodiments, the concentration of Li₂O in the precursor glass composition and the resultant glass-ceramic article may be greater than or equal to 17 mol % and less than or equal to 26 mol %, greater than or equal to 17 mol % and less than or equal to 24 mol %, greater than or equal to 17 mol % and less than or equal to 22 mol %, greater than or equal to 18 mol % and less than or equal to 26 mol %, greater than or equal to 18 mol % and less than or equal to 24 mol %, greater than or equal to 18 mol % and less than or equal to 22 mol %, greater than or equal to 20 mol % and less than or equal to 26 mol %, greater than or equal to 20 mol % and less than or equal to 24 mol %, or even greater than or equal to 20 mol % and less than or equal to 22 mol %, or any and all sub-ranges formed from any of these end points.

In embodiments, a molar ratio of the concentration of Li₂O in the precursor glass composition and the resultant glass-ceramic article to the concentration of Al₂O₃ in the precursor glass composition and the resultant glass-ceramic article (i.e., Li₂O (mol %) to Al₂O₃ (mol %)) may be greater than or equal to 2 and less than or equal to 12 to achieve a crystalline phase including the desired lithium disilicate and petalite. In embodiments, the molar ratio of Li₂O to Al₂O₃ in the precursor glass composition and the resultant glass-ceramic article may be greater than or equal to 4 and less than or equal to 10. In embodiments, the molar ratio of Li₂O to Al₂O₃ in the precursor glass composition and the resultant glass-ceramic article may be greater than or equal to 2 or even greater than or equal to 4. In embodiments, the molar ratio of Li₂O to Al₂O₃ in the precursor glass composition and the resultant glass-ceramic article may be less than or equal to 12, less than or equal to 10, or even less than or equal to 8. In embodiments, the molar ratio of Li₂O to Al₂O₃ in the precursor glass composition and the resultant glass-ceramic article may be greater than or equal to 2 and less than or equal to 12, greater than or equal to 2 and less than or equal to 10, greater than or equal to 2 and less than or equal to 8, greater than or equal to 4 and less than or equal to 12, greater than or equal to 4 and less than or equal to 10, or even greater than or equal to 4 and less than or equal to 8, or any and all sub-ranges formed from any of these endpoints.

In embodiments, a molar ratio of the concentration of Li₂O in the precursor glass composition and the resultant glass-ceramic article to the concentration of SiO₂ in the precursor glass composition and the resultant glass-ceramic article (i.e., Li₂O (mol %) to SiO₂ (mol %)) may be greater than or equal to 0.25 and less than or equal to 0.5 to achieve a crystalline phase including the desired lithium disilicate and petalite. In embodiments, the molar ratio of Li₂O to SiO₂ in the precursor glass composition and the resultant glass-ceramic article may be greater than or equal to 0.25 and less than or equal to 0.4. In embodiments, the molar ratio of Li₂O to SiO₂ in the precursor glass composition and the resultant glass-ceramic article may be greater than or equal to 0.25 or even greater than or equal to 0.3. In embodiments, the molar ratio of Li₂O to SiO₂ in the precursor glass composition and the resultant glass-ceramic article may be less than or equal to 0.5, less than or equal to 0.4, or even less than or equal to 0.35. In embodiments, the molar ratio of Li₂O to SiO₂ in the precursor glass composition and the resultant glass-ceramic article may be greater than or equal to 0.25 and less than or equal to 0.5, greater than or equal to 0.25 and less than or equal to 0.4, greater than or equal to 0.25 and less than or equal to 0.35, greater than or equal to 0.3 and less than or equal to 0.5, greater than or equal to 0.3 and less than or equal to 0.4, or even greater than or equal to 0.3 and less than or equal to 0.35, or any and all sub-ranges formed from any of these endpoints.

The precursor glass compositions and the resultant glass-ceramic articles described herein may further comprise alkali metal oxides other than Li₂O, such as Na₂O and/or K₂O. In addition to aiding in ion exchangeability of the resulting glass-ceramic article, Na₂O decreases the melting point and improves formability of the resulting glass-ceramic article. In embodiments, the precursor glass composition may and the resultant glass-ceramic article comprise greater than or 0 mol % and less than or equal to 6 mol % Na₂O. In embodiments, the concentration of Na₂O in the precursor glass composition and the resultant glass-ceramic article may be greater than or equal to 0 mol % or even greater than or equal to 1 mol %. In embodiments, the concentration of Na₂O in the precursor glass composition and the resultant glass-ceramic article may be less than or equal to 6 mol %, less than or equal to 5 mol % less than or equal to 4 mol %, or even less than or equal to 3 mol %. In embodiments, the concentration of Na₂O in the precursor glass composition and the resultant glass-ceramic article may be greater than or equal to 0 mol % and less than or equal to 6 mol %, greater than or equal to 0 mol % and less than or equal to 5 mol %, greater than or equal to 0 mol % and less than or equal to 4 mol %, greater than or equal to 0 mol % and less than or equal to 3 mol %, greater than or equal to 1 mol % and less than or equal to 6 mol %, greater than or equal to 1 mol % and less than or equal to 5 mol %, greater than or equal to 1 mol % and less than or equal to 4 mol %, or even greater than or equal to 1 mol % and less than or equal to 3 mol %, or any and all sub-ranges formed from any of these endpoints. In embodiments, the precursor glass compositions and the resultant glass-ceramic articles may be substantially free or free of Na₂O.

K₂O promotes ion exchange, increases the depth of compression and decreases the melting point to improve formability of the resulting glass-ceramic article. However, adding K₂O may cause the surface compressive stress and melting point to be too low. In embodiments, the precursor glass composition and the resultant glass-ceramic article may comprise greater than or 0 mol % and less than or equal to 6 mol % K₂O. In embodiments, the concentration of K₂O in the precursor glass composition and the resultant glass-ceramic article may be greater than or equal to 0 mol % or even greater than or equal to 1 mol %. In embodiments, the concentration of K₂O in the precursor glass composition and the resultant glass-ceramic article may be less than or equal to 6 mol %, less than or equal to 5 mol %, less than or equal to 4 mol %, or even less than or equal to 3 mol %. In embodiments, the concentration of K₂O in the precursor glass composition and the resultant glass-ceramic article may be greater than or equal to 0 mol % and less than or equal to 6 mol %, greater than or equal to 0 mol % and less than or equal to 5 mol %, greater than or equal to 0 mol % and less than or equal to 4 mol %, greater than or equal to 0 mol % and less than or equal to 3 mol %, greater than or equal to 1 mol % and less than or equal to 6 mol %, greater than or equal to 1 mol % and less than or equal to 5 mol %, greater than or equal to 1 mol % and less than or equal to 4 mol %, or even greater than or equal to 1 mol % and less than or equal to 3 mol %, or any and all sub-ranges formed from any of these endpoints. In embodiments, the precursor glass compositions and the resultant glass-ceramic articles may be substantially free or free of K₂O.

As used herein, R20 is the sum (in mol %) of Li₂O, Na₂O, and K₂O (i.e., R₂O═Li₂O (mol %)+Na₂O (mol %)+K₂O (mol %)) present in the precursor glass composition and the resultant glass-ceramic article. Alkali oxides, such as Li₂O, Na₂O, and K₂O, aid in decreasing the softening point and molding temperature of the precursor glass composition, thereby offsetting the increase in the softening point and molding temperature of the precursor glass composition due to higher amounts of SiO₂ in the precursor glass composition. The decrease in the softening point and molding temperature may be further reduced by including combinations of alkali oxides (e.g., two or more alkali oxides) in the precursor glass composition, a phenomenon referred to as the “mixed alkali effect.” However, it has been found that if the amount of alkali oxide is too high, the average coefficient of thermal expansion of the precursor glass composition increases to greater than 100×10⁻⁷/° C., which may be undesirable.

In embodiments, the concentration of R₂O in the precursor glass composition and the resultant glass-ceramic article may be greater than or equal to 17 mol % and less than or equal to 30 mol %. In embodiments, the concentration of R₂O in the precursor glass composition and the resultant glass-ceramic article may be greater than or equal to 17 mol %, greater than or equal to 19 mol %, or even greater than or equal to 21 mol %. In embodiments, the concentration of R₂O in the precursor glass composition and the resultant glass-ceramic article may be less than or equal to 30 mol %, less than or equal to 27 mol %, or even less than or equal to 25 mol %. In embodiments, the concentration of R₂O in the precursor glass composition and the resultant glass-ceramic article may be greater than or equal to 17 mol % and less than or equal to 30 mol %, greater than or equal to 17 mol % and less than or equal to 27 mol %, greater than or equal to 17 mol % and less than or equal to 25 mol %, greater than or equal to 19 mol % and less than or equal to 30 mol %, greater than or equal to 19 mol % and less than or equal to 27 mol %, greater than or equal to 19 mol % and less than or equal to 25 mol %, greater than or equal to 21 mol % and less than or equal to 30 mol %, greater than or equal to 21 mol % and less than or equal to 27 mol %, or even greater than or equal to 21 mol % and less than or equal to 25 mol %, or any and all sub-ranges formed from any of these endpoints.

The precursor glass compositions and the resultant glass-ceramic articles described herein further include ZrO₂. ZrO₂ may help decrease the petalite grain size, which may be important to the formation of a transparent or transparent haze glass-ceramic article. Like SiO₂ and Al₂O₃, ZrO₂ may function as a network former, thereby improving the stability of the glass by reducing devitrification during forming and reducing the liquidus temperature. The addition of ZrO₂ may also improve the chemical durability of the resulting glass-ceramic article. In embodiments, the precursor glass composition and the resultant glass-ceramic article may comprise greater than or equal to 0.2 mol % and less than or equal to 4 mol % ZrO₂. In embodiments, the precursor glass composition and the resultant glass-ceramic article may comprise greater than or equal to 0.5 mol % and less than or equal to 4 mol % ZrO₂. In embodiments, the precursor glass composition and the resultant glass-ceramic article may comprise greater than or equal to 1.5 mol % and less than or equal to 4 mol % ZrO₂. In embodiments, the concentration of ZrO₂ in the precursor glass composition and the resultant glass-ceramic article may be greater than or equal to 0.2 mol %, greater than or equal to 0.5 mol %, greater than or equal to 1 mol %, or even greater than or equal to 1.5 mol %. In embodiments, the concentration of ZrO₂ in the precursor glass composition and the resultant glass-ceramic article may be less than or equal to 4 mol % or even less than or equal to 3.5 mol %. In embodiments, the concentration of ZrO₂ in the precursor glass composition and the resultant glass-ceramic article may be greater than or equal to 0.2 mol % and less than or equal to 4 mol %, greater than or equal to 0.2 mol % and less than or equal to 3.5 mol %, greater than or equal to 0.5 mol % and less than or equal to 4 mol %, greater than or equal to 0.5 mol % and less than or equal to 3.5 mol %, greater than or equal to 1 mol % and less than or equal to 4 mol %, greater than or equal to 1 mol % and less than or equal to 3.5 mol %, greater than or equal to 1.5 mol % and less than or equal to 4 mol %, or even greater than or equal to 1.5 mol % and less than or equal to 3.5 mol %, or any and all sub-ranges formed from any of these endpoints.

The precursor glass compositions and the resultant glass-ceramic articles described herein further include P₂O₅. P₂O₅ serves as a nucleating agent to produce bulk nucleation of the crystalline phase in the glass, thereby transforming the glass into a glass-ceramic article. In embodiments, the precursor glass composition and the resultant glass-ceramic article may comprise greater than or equal to 0.5 mol % and less than or equal to 2 mol % P₂O₅. In embodiments, the precursor glass composition and the resultant glass-ceramic article may comprise greater than or equal to 0.7 mol % and less than or equal to 1.75 mol % P₂O₅. In embodiments, the concentration of P₂O₅ in the precursor glass composition and the resultant glass-ceramic article may be greater than or equal to 0.5 mol %, greater than or equal to 0.7 mol %, or even greater than or equal to 0.9 mol %. In embodiments, the concentration of P₂O₅ in the precursor glass composition and the resultant glass-ceramic article may be less than or equal to 2 mol %, less than or equal to 1.75 mol %, less than or equal to 1.5 mol %, or even less than or equal to 1.25 mol %. In embodiments, the concentration of P₂O₅ in the precursor glass composition and the resultant glass-ceramic article may be greater than or equal to 0.5 mol % and less than or equal to 2 mol %, greater than or equal to 0.5 mol % and less than or equal to 1.75 mol %, greater than or equal to 0.5 mol % and less than or equal to 1.5 mol %, greater than or equal to 0.5 mol % and less than or equal to 1.25 mol %, greater than or equal to 0.7 mol % and less than or equal to 2 mol %, greater than or equal to 0.7 mol % and less than or equal to 1.75 mol %, greater than or equal to 0.7 mol % and less than or equal to 1.5 mol %, greater than or equal to 0.7 mol % and less than or equal to 1.25 mol %, greater than or equal to 0.9 mol % and less than or equal to 2 mol %, greater than or equal to 0.9 mol % and less than or equal to 1.75 mol %, greater than or equal to 0.9 mol % and less than or equal to 1.5 mol %, or even greater than or equal to 0.9 mol % and less than or equal to 1.25 mol %, or any and all sub-ranges formed from any of these endpoints.

In embodiments, the sum (in mol %) of P₂O₅ and ZrO₂ (i.e., P₂O₅ (mol %)+ZrO₂ (mol %)) in the precursor glass composition and the resultant glass-ceramic article should be sufficiently high (e.g., greater than or equal to 1 mol %) to produce bulk nucleation of the crystalline phase in the glass, thereby transforming the glass into a glass-ceramic article. The sum of P₂O₅ and ZrO₂ may be limited (e.g., less than or equal to 6 mol %) to produce a transparent or transparent haze glass-ceramic article. Accordingly, in embodiments, the sum of P₂O₅ and ZrO₂ may be greater than or equal to 1 mol % and less than or equal to 6 mol %. In embodiments, P₂O₅+ZrO₂ in the precursor glass composition and the resultant glass-ceramic article may be greater than or equal to 2 mol % and less than or equal to 5 mol %. In embodiments, P₂O₅+ZrO₂ in the precursor glass composition and the resultant glass-ceramic article may be greater than or equal to 1 mol % or even greater than or equal to 2 mol %. In embodiments P₂O₅+ZrO₂ in the precursor glass composition and the resultant glass-ceramic article may be less than or equal to 6 mol %, less than or equal to 5 mol %, or even less than or equal to 4 mol %. In embodiments, P₂O₅+ZrO₂ in the precursor glass composition and the resultant glass-ceramic article may be greater than or equal to 1 mol % and less than or equal to 6 mol %, greater than or equal to 1 mol % and less than or equal to 5 mol %, greater than or equal 1 mol % and less than or equal to 4 mol %, greater than or equal to 2 mol % and less than or equal to 6 mol %, greater than or equal to 2 mol % and less than or equal to 5 mol %, or even greater than or equal 2 mol % and less than or equal to 4 mol %, or any and all sub-ranges formed from any of these endpoints.

In embodiments, the molar ratio of the sum (in mol %) of SiO₂ and Al₂O₃ (i.e., SiO₂ (mol %)+Al₂O₃ (mol %)) to the sum (in mol %) of P₂O₅ and ZrO₂ (i.e., P₂O₅ (mol %)+ZrO₂ (mol %)), represented as (SiO₂ (mol %)+Al₂O₃ (mol %))/(P₂O₅ (mol %)+ZrO₂ (mol %)), in the precursor glass composition and the resultant glass-ceramic article may be greater than or equal to 12 mol % and less than or equal to 34 mol % to ensure formation of the desired litihium disilicate and petalite phases. While not wishing to be bound by theory, it is believed that (SiO₂ (mol %)+Al₂O₃ (mol %))/(P₂O₅ (mol %)+ZrO₂ (mol %)) in the precursor glass composition and the resultant glass-ceramic article greater than 34 mol % may result in the formation of other crystalline phases, such as a quartz phase. In embodiments, (SiO₂ (mol %)+Al₂O₃ (mol %))/(P₂O₅ (mol %)+ZrO₂ (mol %)) in the precursor glass composition and the resultant glass-ceramic article may be greater than or equal to 14 mol % and less than or equal to 32 mol %. In embodiments, (SiO₂ (mol %)+Al₂O₃ (mol %))/(P₂O₅ (mol %)+ZrO₂ (mol %)) in the precursor glass composition and the resultant glass-ceramic article may be greater than or equal to 12 mol %, greater than or equal to 14 mol %, greater than or equal to 16 mol %, greater than or equal to 18 mol %, or even greater than or equal to 20 mol %. In embodiments, (SiO₂ (mol %)+Al₂O₃ (mol %))/(P₂O₅ (mol %)+ZrO₂ (mol %)) in the precursor glass composition and the resultant glass-ceramic article may be less than or equal to 34 mol %, less than or equal to 32 mol %, less than or equal to 30 mol %, or even less than or equal to 28 mol %. In embodiments, (SiO₂ (mol %)+Al₂O₃ (mol %))/(P₂O₅ (mol %)+ZrO₂ (mol %)) in the precursor glass composition and the resultant glass-ceramic article may be greater than or equal to 12 mol % and less than or equal to 34 mol %, greater than or equal to 12 mol % and less than or equal to 32 mol %, greater than or equal to 12 mol % and less than or equal to 30 mol %, greater than or equal to 12 mol % and less than or equal to 28 mol %, greater than or equal to 14 mol % and less than or equal to 34 mol %, greater than or equal to 14 mol % and less than or equal to 32 mol %, greater than or equal to 14 mol % and less than or equal to 30 mol %, greater than or equal to 14 mol % and less than or equal to 28 mol %, greater than or equal to 16 mol % and less than or equal to 34 mol %, greater than or equal to 16 mol % and less than or equal to 32 mol %, greater than or equal to 16 mol % and less than or equal to 30 mol %, greater than or equal to 16 mol % and less than or equal to 28 mol %, greater than or equal to 18 mol % and less than or equal to 34 mol %, greater than or equal to 18 mol % and less than or equal to 32 mol %, greater than or equal to 18 mol % and less than or equal to 30 mol %, greater than or equal to 18 mol % and less than or equal to 28 mol %, greater than or equal to 20 mol % and less than or equal to 34 mol %, greater than or equal to 20 mol % and less than or equal to 32 mol %, greater than or equal to 20 mol % and less than or equal to 30 mol %, or even greater than or equal to 20 mol % and less than or equal to 28 mol %, or any and all sub-ranges formed from any of these endpoints.

The precursor glass compositions and the resultant glass-ceramic articles described herein further include alkaline earth oxides and/or transition metal oxides. The alkaline earth oxides and transition metal oxides may largely partition into the residual glass phase during crystallization, which results in packing of the glass network. Although alkali diffusivity during ion exchange may slow down due to the glass network being more highly packed due to the presence of the alkaline earth oxides and/or transition metal oxides, the ions exchanging into the glass network create relatively more stress per ion than a glass network with less packing. More stress leads to an increase in the maximum central tension of the resulting glass-ceramic article. Accordingly, including alkaline earth oxides and/or transition metal oxides in the precursor glass composition may increase the maximum central tension of the resulting glass-ceramic article.

“Alkaline earth oxides” is the sum (in mol %) of CaO, MgO, SrO, and BaO (i.e. alkaline earth oxides=CaO (mol %)+MgO (mol %)+SrO (mol %)+BaO (mol %)) present in the precursor glass composition and the resultant glass-ceramic article. “Transition metal oxides” is the sum (in mol %) of La₂O₃, Y₂O₃, Ta₂O₅, and GeO₂ (i.e., transition metal oxides=La₂O₃ (mol %)+Y₂O₃ (mol %)+Ta₂O₅ (mol %)+GeO₂ (mol %)) present in the precursor glass composition and the resultant glass-ceramic article. In embodiments, the sum (in mol %) of alkaline earth oxides and transition metal oxides (i.e., alkaline earth oxides (mol %)+transition metal oxides (mol %)) in the precursor glass composition and the resultant glass-ceramic article may be greater than or equal to 0.1 mol % and less than or equal to 6 mol %. In embodiments, the sum of alkaline earth oxides and transition metal oxides in the precursor glass composition and the resultant glass-ceramic article may be greater than or equal to 0.1 mol % and less than or equal to 5 mol %. In embodiments, the sum of alkaline earth oxides and transition metal oxides in the precursor glass composition and the resultant glass-ceramic article may be greater than or equal to 0.1 mol %, greater than or equal to 0.2 mol %, greater than or equal to 0.5 mol %, greater than or equal to 0.7 mol %, or even greater than or equal to 1 mol %. In embodiments, the sum of alkaline earth oxides and transition metal oxides in the precursor glass composition and the resultant glass-ceramic article may be less than or equal to 6 mol %, less than or equal to 5 mol %, less than or equal to 4 mol %, less than or equal to 3 mol %, or even less than or equal to 2 mol %. In embodiments, the sum of alkaline earth oxides and transition metal oxides in the precursor glass composition and the resultant glass-ceramic article may be greater than or equal to 0.1 mol % and less than or equal to 6 mol %, greater than or equal to 0.1 mol % and less than or equal to 5 mol %, greater than or equal to 0.1 mol % and less than or equal to 4 mol %, greater than or equal to 0.1 mol % and less than or equal to 3 mol %, greater than or equal to 0.1 mol % and less than or equal to 2 mol %, greater than or equal to 0.2 mol % and less than or equal to 6 mol %, greater than or equal to 0.2 mol % and less than or equal to 5 mol %, greater than or equal to 0.2 mol % and less than or equal to 4 mol %, greater than or equal to 0.2 mol % and less than or equal to 3 mol %, greater than or equal to 0.2 mol % and less than or equal to 2 mol %, greater than or equal to 0.5 mol % and less than or equal to 6 mol %, greater than or equal to 0.5 mol % and less than or equal to 5 mol %, greater than or equal to 0.5 mol % and less than or equal to 4 mol %, greater than or equal to 0.5 mol % and less than or equal to 3 mol %, greater than or equal to 0.5 mol % and less than or equal to 2 mol %, greater than or equal to 0.7 mol % and less than or equal to 6 mol %, greater than or equal to 0.7 mol % and less than or equal to 5 mol %, greater than or equal to 0.7 mol % and less than or equal to 4 mol %, greater than or equal to 0.7 mol % and less than or equal to 3 mol %, greater than or equal to 0.7 mol % and less than or equal to 2 mol %, greater than or equal to 1 mol % and less than or equal to 6 mol %, greater than or equal to 1 mol % and less than or equal to 5 mol %, greater than or equal to 1 mol % and less than or equal to 4 mol %, greater than or equal to 1 mol % and less than or equal to 3 mol %, or even greater than or equal to 1 mol % and less than or equal to 2 mol %, or any and all sub-ranges formed from any of these endpoints.

In embodiments, the precursor glass composition and the resultant glass-ceramic article may comprise greater than or equal to 0 mol % and less than or equal to 8 mol % CaO. In embodiments, the concentration of CaO in the precursor glass composition and the resultant glass-ceramic article may be greater than or equal to 0 mol %, greater than or equal to 1 mol %, or even greater than or equal to 2 mol %. In embodiments, the concentration of CaO in the precursor glass composition and the resultant glass-ceramic article may be less than or equal to 8 mol %, less than or equal to 7 mol %, less than or equal to 6 mol %, less than or equal to 5 mol %, or even less than or equal to 4 mol %. In embodiments, the concentration of CaO in the precursor glass composition and the resultant glass-ceramic article may be greater than or equal to 0 mol % and less than or equal to 8 mol %, greater than or equal to 0 mol % and less than or equal to 7 mol %, greater than or equal to 0 mol % and less than or equal to 6 mol %, greater than or equal to 0 mol % and less than or equal to 5 mol %, greater than or equal to 0 mol % and less than or equal to 4 mol %, greater than or equal to 1 mol % and less than or equal to 8 mol %, greater than or equal to 1 mol % and less than or equal to 7 mol %, greater than or equal to 1 mol % and less than or equal to 6 mol %, greater than or equal to 1 mol % and less than or equal to 5 mol %, greater than or equal to 1 mol % and less than or equal to 4 mol %, greater than or equal to 2 mol % and less than or equal to 8 mol %, greater than or equal to 2 mol % and less than or equal to 7 mol %, greater than or equal to 2 mol % and less than or equal to 6 mol %, greater than or equal to 2 mol % and less than or equal to 5 mol %, or even greater than or equal to 2 mol % and less than or equal to 4 mol %, or any and all sub-ranges formed from any of these endpoints. In embodiments, the precursor glass compositions and the resultant glass-ceramic articles may be substantially free or free of CaO.

In embodiments, the precursor glass composition and the resultant glass-ceramic article may comprise greater than or equal to 0 mol % and less than or equal to 8 mol % MgO. In embodiments, the concentration of MgO in the precursor glass composition and the resultant glass-ceramic article may be greater than or equal to 0 mol %, greater than or equal to 1 mol %, or even greater than or equal to 2 mol %. In embodiments, the concentration of MgO in the precursor glass composition and the resultant glass-ceramic article may be less than or equal to 8 mol %, less than or equal to 7 mol %, less than or equal to 6 mol %, less than or equal to 5 mol %, or even less than or equal to 4 mol %. In embodiments, the concentration of MgO in the precursor glass composition and the resultant glass-ceramic article may be greater than or equal to 0 mol % and less than or equal to 8 mol %, greater than or equal to 0 mol % and less than or equal to 7 mol %, greater than or equal to 0 mol % and less than or equal to 6 mol %, greater than or equal to 0 mol % and less than or equal to 5 mol %, greater than or equal to 0 mol % and less than or equal to 4 mol %, greater than or equal to 1 mol % and less than or equal to 8 mol %, greater than or equal to 1 mol % and less than or equal to 7 mol %, greater than or equal to 1 mol % and less than or equal to 6 mol %, greater than or equal to 1 mol % and less than or equal to 5 mol %, greater than or equal to 1 mol % and less than or equal to 4 mol %, greater than or equal to 2 mol % and less than or equal to 8 mol %, greater than or equal to 2 mol % and less than or equal to 7 mol %, greater than or equal to 2 mol % and less than or equal to 6 mol %, greater than or equal to 2 mol % and less than or equal to 5 mol %, or even greater than or equal to 2 mol % and less than or equal to 4 mol %, or any and all sub-ranges formed from any of these endpoints. In embodiments, the precursor glass compositions and the resultant glass-ceramic articles may be substantially free or free of MgO.

In embodiments, the precursor glass composition and the resultant glass-ceramic article may comprise greater than or equal to 0 mol % and less than or equal to 8 mol % SrO. In embodiments, the concentration of SrO in the precursor glass composition and the resultant glass-ceramic article may be greater than or equal to 0 mol %, greater than or equal to 1 mol %, or even greater than or equal to 2 mol %. In embodiments, the concentration of SrO in the precursor glass composition and the resultant glass-ceramic article may be less than or equal to 8 mol %, less than or equal to 7 mol %, less than or equal to 6 mol %, less than or equal to 5 mol %, or even less than or equal to 4 mol %. In embodiments, the concentration of SrO in the precursor glass composition and the resultant glass-ceramic article may be greater than or equal to 0 mol % and less than or equal to 8 mol %, greater than or equal to 0 mol % and less than or equal to 7 mol %, greater than or equal to 0 mol % and less than or equal to 6 mol %, greater than or equal to 0 mol % and less than or equal to 5 mol %, greater than or equal to 0 mol % and less than or equal to 4 mol %, greater than or equal to 1 mol % and less than or equal to 8 mol %, greater than or equal to 1 mol % and less than or equal to 7 mol %, greater than or equal to 1 mol % and less than or equal to 6 mol %, greater than or equal to 1 mol % and less than or equal to 5 mol %, greater than or equal to 1 mol % and less than or equal to 4 mol %, greater than or equal to 2 mol % and less than or equal to 8 mol %, greater than or equal to 2 mol % and less than or equal to 7 mol %, greater than or equal to 2 mol % and less than or equal to 6 mol %, greater than or equal to 2 mol % and less than or equal to 5 mol %, or even greater than or equal to 2 mol % and less than or equal to 4 mol %, or any and all sub-ranges formed from any of these endpoints. In embodiments, the precursor glass compositions and the resultant glass-ceramic articles may be substantially free or free of SrO.

In embodiments, the precursor glass composition and the resultant glass-ceramic article may comprise greater than or equal to 0 mol % and less than or equal to 8 mol % BaO. In embodiments, the concentration of BaO in the precursor glass composition and the resultant glass-ceramic article may be greater than or equal to 0 mol %, greater than or equal to 1 mol %, or even greater than or equal to 2 mol %. In embodiments, the concentration of BaO in the precursor glass composition and the resultant glass-ceramic article may be less than or equal to 8 mol %, less than or equal to 7 mol %, less than or equal to 6 mol %, less than or equal to 5 mol %, or even less than or equal to 4 mol %. In embodiments, the concentration of BaO in the precursor glass composition and the resultant glass-ceramic article may be greater than or equal to 0 mol % and less than or equal to 8 mol %, greater than or equal to 0 mol % and less than or equal to 7 mol %, greater than or equal to 0 mol % and less than or equal to 6 mol %, greater than or equal to 0 mol % and less than or equal to 5 mol %, greater than or equal to 0 mol % and less than or equal to 4 mol %, greater than or equal to 1 mol % and less than or equal to 8 mol %, greater than or equal to 1 mol % and less than or equal to 7 mol %, greater than or equal to 1 mol % and less than or equal to 6 mol %, greater than or equal to 1 mol % and less than or equal to 5 mol %, greater than or equal to 1 mol % and less than or equal to 4 mol %, greater than or equal to 2 mol % and less than or equal to 8 mol %, greater than or equal to 2 mol % and less than or equal to 7 mol %, greater than or equal to 2 mol % and less than or equal to 6 mol %, greater than or equal to 2 mol % and less than or equal to 5 mol %, or even greater than or equal to 2 mol % and less than or equal to 4 mol %, or any and all sub-ranges formed from any of these endpoints. In embodiments, the precursor glass compositions and the resultant glass-ceramic articles may be substantially free or free of BaO.

In embodiments, the concentration of alkaline earth oxides in the precursor glass composition and the resultant glass-ceramic article may be greater than or equal to 0 mol %, greater than or equal to 0.1 mol %, greater than or equal to 0.2 mol %, greater than or equal to 0.5 mol %, greater than or equal to 0.7 mol %, or even greater than or equal to 1 mol %. In embodiments, the concentration of alkaline earth oxides in the precursor glass composition and the resultant glass-ceramic article may be less than or equal to 10 mol %, less than or equal to 6 mol %, less than or equal to 4 mol %, less than or equal to 3 mol %, or even less than or equal to 2 mol %. In embodiments, the concentration of alkaline earth oxides in the precursor glass composition and the resultant glass-ceramic article may be greater than or equal to 0 mol % and less than or equal to 10 mol %, greater than or equal to 0 mol % and less than or equal to 6 mol %, greater than or equal to 0 mol % and less than or equal to 4 mol %, greater than or equal to 0 mol % and less than or equal to 3 mol %, greater than or equal to 0 mol % and less than or equal to 2 mol %, greater than or equal to 0.1 mol % and less than or equal to 10 mol %, greater than or equal to 0.1 mol % and less than or equal to 6 mol %, greater than or equal to 0.1 mol % and less than or equal to 4 mol %, greater than or equal to 0.1 mol % and less than or equal to 3 mol %, greater than or equal to 0.1 mol % and less than or equal to 2 mol %, greater than or equal to 0.2 mol % and less than or equal to 10 mol %, greater than or equal to 0.2 mol % and less than or equal to 6 mol %, greater than or equal to 0.2 mol % and less than or equal to 4 mol %, greater than or equal to 0.2 mol % and less than or equal to 3 mol %, greater than or equal to 0.2 mol % and less than or equal to 2 mol %, greater than or equal to 0.5 mol % and less than or equal to 10 mol %, greater than or equal to 0.5 mol % and less than or equal to 6 mol %, greater than or equal to 0.5 mol % and less than or equal to 4 mol %, greater than or equal to 0.5 mol % and less than or equal to 3 mol %, greater than or equal to 0.5 mol % and less than or equal to 2 mol %, greater than or equal to 0.7 mol % and less than or equal to 10 mol %, greater than or equal to 0.7 mol % and less than or equal to 6 mol %, greater than or equal to 0.7 mol % and less than or equal to 4 mol %, greater than or equal to 0.7 mol % and less than or equal to 3 mol %, greater than or equal to 0.7 mol % and less than or equal to 2 mol %, greater than or equal to 1 mol % and less than or equal to 10 mol %, greater than or equal to 1 mol % and less than or equal to 6 mol %, greater than or equal to 1 mol % and less than or equal to 4 mol %, greater than or equal to 1 mol % and less than or equal to 3 mol %, or even greater than or equal to 1 mol % and less than or equal to 2 mol %, or any and all sub-ranges formed from any of these endpoints. In embodiments, the precursor glass compositions and the resultant glass-ceramic articles may be substantially free or free of alkaline earth oxides.

In embodiments, the precursor glass composition and the resultant glass-ceramic article may comprise greater than or equal to 0 mol % and less than or equal to 4 mol % La₂O₃. In embodiments, the concentration of in La₂O₃ in the precursor glass composition and the resultant glass-ceramic article may be greater than or equal to 0 mol %, greater than or equal to 0.1 mol %, greater than or equal to 0.2 mol %, or even greater than or equal to 0.5 mol %. In embodiments, the concentration of in La₂O₃ the precursor glass composition and the resultant glass-ceramic article may be less than or equal to 4 mol %, less than or equal to 3 mol %, less than or equal to 2 mol %, or even less than or equal to 1 mol %. In embodiments, the concentration of in La₂O₃ the precursor glass composition and the resultant glass-ceramic article may be greater than or equal to 0 mol % and less than or equal to 4 mol %, greater than or equal to 0 mol % and less than or equal to 3 mol %, greater than or equal to 0 mol % and less than or equal to 2 mol %, greater than or equal to 0 mol % and less than or equal to 1 mol %, greater than or equal to 0.1 mol % and less than or equal to 4 mol %, greater than or equal to 0.1 mol % and less than or equal to 3 mol %, greater than or equal to 0.1 mol % and less than or equal to 2 mol %, greater than or equal to 0.1 mol % and less than or equal to 1 mol %, greater than or equal to 0.2 mol % and less than or equal to 4 mol %, greater than or equal to 0.2 mol % and less than or equal to 3 mol %, greater than or equal to 0.2 mol % and less than or equal to 2 mol %, greater than or equal to 0.2 mol % and less than or equal to 1 mol %, greater than or equal to 0.5 mol % and less than or equal to 4 mol %, greater than or equal to 0.5 mol % and less than or equal to 3 mol %, greater than or equal to 0.5 mol % and less than or equal to 2 mol %, or even greater than or equal to 0.5 mol % and less than or equal to 1 mol %, or any and all sub-ranges formed from any of these endpoints. In embodiments, the precursor glass compositions and the resultant glass-ceramic articles may be substantially free or free of La₂O₃.

In embodiments, the precursor glass composition and the resultant glass-ceramic article may comprise greater than or equal to 0 mol % and less than or equal to 6 mol % Y₂O₃. In embodiments, the concentration of Y₂O₃ in the precursor glass composition and the resultant glass-ceramic article may be greater than or equal to 0 mol %, greater than or equal to 0.1 mol %, greater than or equal to 0.5 mol %, or even greater than or equal to 1 mol %. In embodiments, the concentration of Y₂O₃ in the precursor glass composition and the resultant glass-ceramic article may be less than or equal to 6 mol %, less than or equal to 5 mol %, less than or equal to 4 mol %, less than or equal to 3 mol %, or even less than or equal to 2 mol %. In embodiments, the concentration of Y₂O₃ in the precursor glass composition and the resultant glass-ceramic article may be greater than or equal to 0 mol % and less than or 6 mol %, greater than or equal to 0 mol % and less than or equal to 5 mol %, greater than or equal to 0 mol % and less than or equal to 4 mol %, greater than or equal to 0 mol % and less than or equal to 3 mol %, greater than or equal to 0 mol % and less than or equal to 2 mol %, greater than or equal to 0.1 mol % and less than or 6 mol %, greater than or equal to 0.1 mol % and less than or equal to 5 mol %, greater than or equal to 0.1 mol % and less than or equal to 4 mol %, greater than or equal to 0.1 mol % and less than or equal to 3 mol %, greater than or equal to 0.1 mol % and less than or equal to 2 mol %, greater than or equal to 0.5 mol % and less than or 6 mol %, greater than or equal to 0.5 mol % and less than or equal to 5 mol %, greater than or equal to 0.5 mol % and less than or equal to 4 mol %, greater than or equal to 0.5 mol % and less than or equal to 3 mol %, greater than or equal to 0.5 mol % and less than or equal to 2 mol %, greater than or equal to 1 mol % and less than or 6 mol %, greater than or equal to 1 mol % and less than or equal to 5 mol %, greater than or equal to 1 mol % and less than or equal to 4 mol %, greater than or equal to 1 mol % and less than or equal to 3 mol %, or even greater than or equal to 1 mol % and less than or equal to 2 mol %, or any and all sub-ranges formed from any of these endpoints. In embodiments, the precursor glass compositions and the resultant glass-ceramic articles may be substantially free or free of Y₂O₃.

In embodiments, the precursor glass composition and the resultant glass-ceramic article may comprise greater than or equal to 0 mol % and less than or equal to 3 mol % Ta₂O₅. In embodiments, the concentration of Ta₂O₅ in the precursor glass composition and the resultant glass-ceramic article may be greater than or equal to 0 mol %, greater than or equal to 0.1 mol %, greater than or equal to 0.2 mol %, or even greater than or equal to 0.5 mol %. In embodiments, the concentration of Ta₂O₅ in the precursor glass composition and the resultant glass-ceramic article may be less than or equal to 3 mol %, less than or equal to 2 mol %, or even less than or equal to 1 mol %. In embodiments, the concentration of Ta₂O₅ in the precursor glass composition and the resultant glass-ceramic article may be greater than or equal to 0 mol % and less than or equal to 3 mol %, greater than or equal to 0 mol % and less than or equal to 2 mol %, greater than or equal to 0 mol % and less than or equal to 1 mol %, greater than or equal to 0.1 mol % and less than or equal to 3 mol %, greater than or equal to 0.1 mol % and less than or equal to 2 mol %, greater than or equal to 0.1 mol % and less than or equal to 1 mol %, greater than or equal to 0.2 mol % and less than or equal to 3 mol %, greater than or equal to 0.2 mol % and less than or equal to 2 mol %, greater than or equal to 0.2 mol % and less than or equal to 1 mol %, greater than or equal to 0.5 mol % and less than or equal to 3 mol %, greater than or equal to 0.5 mol % and less than or equal to 2 mol %, or even greater than or equal to 0.5 mol % and less than or equal to 1 mol %, or any and all sub-ranges formed from any of these endpoints. In embodiments, the precursor glass compositions and the resultant glass-ceramic articles may be substantially free or free of Ta₂O₅.

In embodiments, the precursor glass composition and the resultant glass-ceramic article may comprise greater than or equal to 0 mol % and less than or equal to 2 mol % GeO₂. In embodiments, the concentration of GeO₂ in the precursor glass composition and the resultant glass-ceramic article may be greater than or equal to 0 mol %, greater than or equal to 0.1 mol %, greater than or equal to 0.2 mol %, or even greater than or equal to 0.5 mol %. In embodiments, the concentration of GeO₂ in the precursor glass composition and the resultant glass-ceramic article may be less than or equal to 2 mol % or even less than or equal to 1 mol %. In embodiments, the concentration of GeO₂ in the precursor glass composition and the resultant glass-ceramic article may be greater than or equal to 0 mol % and less than or equal to 2 mol %, greater than or equal to 0 mol % and less than or equal to 1 mol %, greater than or equal to 0.1 mol % and less than or equal to 2 mol %, greater than or equal to 0.1 mol % and less than or equal to 1 mol %, greater than or equal to 0.2 mol % and less than or equal to 2 mol %, greater than or equal to 0.2 mol % and less than or equal to 1 mol %, greater than or equal to 0.5 mol % and less than or equal to 2 mol %, or even greater than or equal to 0.5 mol % and less than or equal to 1 mol %, or any and all sub-ranges formed from any of these endpoints. In embodiments, the precursor glass compositions and the resultant glass-ceramic articles may be substantially free or free of GeO₂.

In embodiments, the concentration of transition metal oxides in the precursor glass composition and the resultant glass-ceramic article may be greater than or equal to 0 mol %, greater than or equal to 0.1 mol %, greater than or equal to 0.2 mol %, greater than or equal to 0.5 mol %, greater than or equal to 0.7 mol %, or even greater than or equal to 1 mol %. In embodiments, the concentration of transition metal oxides in the precursor glass composition and the resultant glass-ceramic article may be less than or equal to 10 mol %, less than or equal to 6 mol %, less than or equal to 4 mol %, less than or equal to 3 mol %, or even less than or equal to 2 mol %. In embodiments, the concentration of transition metal oxides in the precursor glass composition and the resultant glass-ceramic article may be greater than or equal to 0 mol % and less than or equal to 10 mol %, greater than or equal to 0 mol % and less than or equal to 6 mol %, greater than or equal to 0 mol % and less than or equal to 4 mol %, greater than or equal to 0 mol % and less than or equal to 3 mol %, greater than or equal to 0 mol % and less than or equal to 2 mol %, greater than or equal to 0.1 mol % and less than or equal to 10 mol %, greater than or equal to 0.1 mol % and less than or equal to 6 mol %, greater than or equal to 0.1 mol % and less than or equal to 4 mol %, greater than or equal to 0.1 mol % and less than or equal to 3 mol %, greater than or equal to 0.1 mol % and less than or equal to 2 mol %, greater than or equal to 0.2 mol % and less than or equal to 10 mol %, greater than or equal to 0.2 mol % and less than or equal to 6 mol %, greater than or equal to 0.2 mol % and less than or equal to 4 mol %, greater than or equal to 0.2 mol % and less than or equal to 3 mol %, greater than or equal to 0.2 mol % and less than or equal to 2 mol %, greater than or equal to 0.5 mol % and less than or equal to 10 mol %, greater than or equal to 0.5 mol % and less than or equal to 6 mol %, greater than or equal to 0.5 mol % and less than or equal to 4 mol %, greater than or equal to 0.5 mol % and less than or equal to 3 mol %, greater than or equal to 0.5 mol % and less than or equal to 2 mol %, greater than or equal to 0.7 mol % and less than or equal to 10 mol %, greater than or equal to 0.7 mol % and less than or equal to 6 mol %, greater than or equal to 0.7 mol % and less than or equal to 4 mol %, greater than or equal to 0.7 mol % and less than or equal to 3 mol %, greater than or equal to 0.7 mol % and less than or equal to 2 mol %, greater than or equal to 1 mol % and less than or equal to 10 mol %, greater than or equal to 1 mol % and less than or equal to 6 mol %, greater than or equal to 1 mol % and less than or equal to 4 mol %, greater than or equal to 1 mol % and less than or equal to 3 mol %, or even greater than or equal to 1 mol % and less than or equal to 2 mol %, or any and all sub-ranges formed from any of these endpoints. In embodiments, the precursor glass compositions and the resultant glass-ceramic articles may be substantially free or free of transition metal oxides.

In embodiments, the precursor glass composition and the resultant glass-ceramic article may comprise greater than or equal to 0 mol % and less than or equal to 10 mol % ZnO. In embodiments, the concentration of ZnO in the precursor glass composition and the resultant glass-ceramic article may be greater than or equal to 0 mol % or even greater than or equal to 1 mol %. In embodiments, the concentration of ZnO in the precursor glass composition and the resultant glass-ceramic article may be less than or equal to 10 mol %, less than or equal to 6 mol %, less than or equal to 4, less than or equal to 3 mol %, or even less than or equal to 2 mol %. In embodiments, the concentration of ZnO in the precursor glass composition and the resultant glass-ceramic article may be greater than or equal to 0 mol % and less than or equal to 10 mol %, greater than or equal to 0 mol % and less than or equal to 6 mol %, greater than or equal to 0 mol % and less than or equal to 4 mol %, greater than or equal to 0 mol % and less than or equal to 3 mol %, greater than or equal to 0 mol % and less than or equal to 2 mol %, greater than or equal to 1 mol % and less than or equal to 10 mol %, greater than or equal to 1 mol % and less than or equal to 6 mol %, greater than or equal to 1 mol % and less than or equal to 4 mol %, greater than or equal to 1 mol % and less than or equal to 3 mol %, or even greater than or equal to 1 mol % and less than or equal to 2 mol %, or any and all sub-ranges formed from any of these endpoints. In embodiments, the precursor glass compositions and the resultant glass-ceramic articles may be substantially free or free of ZnO.

As used herein, RO is the sum (in mol %) of CaO, MgO, ZnO, SrO, and BaO (i.e. RO═CaO (mol %)+MgO (mol %)+ZnO (mol %)+SrO (mol %)+BaO (mol %)) present in the precursor glass composition and the resultant glass-ceramic article. In embodiments, the concentration of RO in the precursor glass composition and the resultant glass-ceramic article may be greater than or equal to 0 mol %, greater than or equal to 0.1 mol %, greater than or equal to 0.2 mol %, greater than or equal to 0.5 mol %, greater than or equal to 0.7 mol %, or even greater than or equal to 1 mol %. In embodiments, the concentration of RO in the precursor glass composition and the resultant glass-ceramic article may be less than or equal to 10 mol %, less than or equal to 6 mol %, less than or equal to 4 mol %, less than or equal to 3 mol %, or even less than or equal to 2 mol %. In embodiments, the concentration of RO in the precursor glass composition and the resultant glass-ceramic article may be greater than or equal to 0 mol % and less than or equal to 10 mol %, greater than or equal to 0 mol % and less than or equal to 6 mol %, greater than or equal to 0 mol % and less than or equal to 4 mol %, greater than or equal to 0 mol % and less than or equal to 3 mol %, greater than or equal to 0 mol % and less than or equal to 2 mol %, greater than or equal to 0.1 mol % and less than or equal to 10 mol %, greater than or equal to 0.1 mol % and less than or equal to 6 mol %, greater than or equal to 0.1 mol % and less than or equal to 4 mol %, greater than or equal to 0.1 mol % and less than or equal to 3 mol %, greater than or equal to 0.1 mol % and less than or equal to 2 mol %, greater than or equal to 0.2 mol % and less than or equal to 10 mol %, greater than or equal to 0.2 mol % and less than or equal to 6 mol %, greater than or equal to 0.2 mol % and less than or equal to 4 mol %, greater than or equal to 0.2 mol % and less than or equal to 3 mol %, greater than or equal to 0.2 mol % and less than or equal to 2 mol %, greater than or equal to 0.5 mol % and less than or equal to 10 mol %, greater than or equal to 0.5 mol % and less than or equal to 6 mol %, greater than or equal to 0.5 mol % and less than or equal to 4 mol %, greater than or equal to 0.5 mol % and less than or equal to 3 mol %, greater than or equal to 0.5 mol % and less than or equal to 2 mol %, greater than or equal to 0.7 mol % and less than or equal to 10 mol %, greater than or equal to 0.7 mol % and less than or equal to 6 mol %, greater than or equal to 0.7 mol % and less than or equal to 4 mol %, greater than or equal to 0.7 mol % and less than or equal to 3 mol %, greater than or equal to 0.7 mol % and less than or equal to 2 mol %, greater than or equal to 1 mol % and less than or equal to 10 mol %, greater than or equal to 1 mol % and less than or equal to 6 mol %, greater than or equal to 1 mol % and less than or equal to 4 mol %, greater than or equal to 1 mol % and less than or equal to 3 mol %, or even greater than or equal to 1 mol % and less than or equal to 2 mol %, or any and all sub-ranges formed from any of these endpoints. In embodiments, the precursor glass compositions and the resultant glass-ceramic articles may be substantially free or free of RO.

The precursor glass compositions and the resultant glass-ceramic articles described herein may further include B₂O₃. B₂O₃ decreases the melting temperature of the precursor glass composition. Furthermore, the addition of B₂O₃ in the precursor glass composition helps achieve an interlocking crystal microstructure when the precursor glass compositions are subjected to heat treatment to form a glass-ceramic article. In addition, B₂O₃ may also improve the damage resistance of the resulting glass-ceramic article. When boron in the residual glass phase present after heat treatment is not charge balanced by alkali oxides or divalent cation oxides (such as MgO, CaO, SrO, BaO, and ZnO), the boron will be in a trigonal-coordination state (or three-coordinated boron), which opens up the structure of the glass. The network around these three-coordinated boron atoms is not as rigid as tetrahedrally coordinated (or four-coordinated) boron. Without being bound by theory, it is believed that glass-ceramic articles that include three-coordinated boron can tolerate some degree of deformation before crack formation compared to four-coordinated boron. By tolerating some deformation, the Vickers indentation crack initiation threshold values increase. Fracture toughness of the glass-ceramic articles that include three-coordinated boron may also increase. B₂O₃ may be included (e.g., greater than or equal to 0 mol %) to improve formability and increase the fracture toughness of the resulting glass-ceramic article. However, if the concentration of B₂O₃ is too high, the chemical durability and liquidus viscosity may diminish and volatilization and evaporation of B₂O₃ during melting becomes difficult to control. Therefore, the concentration of B₂O₃ may be limited (e.g., less than or equal to 8 mol %) to maintain chemical durability and manufacturability of the precursor glass composition.

In embodiments, the precursor glass composition and the resultant glass-ceramic article may comprise greater than or equal to 0 mol % and less than or equal to 8 mol % B₂O₃. In embodiments, the concentration of B₂O₃ in the precursor glass composition and the resultant glass-ceramic article may be greater than or equal to 0 mol %, greater than or equal to 1 mol %, or even greater than or equal to 3 mol %. In embodiments, the concentration of B₂O₃ in the precursor glass composition and the resultant glass-ceramic article may be less than or equal to 8 mol % or even less than or equal to 5 mol %. In embodiments, the concentration of B₂O₃ in the precursor glass composition and the resultant glass-ceramic article may be greater than or equal to 0 mol % and less than or equal to 8 mol %, greater than or equal to 0 mol % and less than or equal to 5 mol %, greater than or equal to 1 mol % and less than or equal to 8 mol %, greater than or equal to 1 mol % and less than or equal to 5 mol %, greater than or equal to 3 mol % and less than or equal to 8 mol %, or even greater than or equal to 3 mol % and less than or equal to 5 mol %, or any and all sub-ranges formed from any of these endpoints. In embodiments, the precursor glass compositions and the resultant glass-ceramic articles may be substantially free or free of B₂O₃.

In embodiments, the precursor glass compositions and the resultant glass-ceramic articles described herein may further include tramp materials such as TiO₂, MnO, MoO₃, WO₃, CdO, As₂O₃, Sb₂O₃, sulfur-based compounds, such as sulfates, halogens, or combinations thereof. In embodiments, the precursor glass compositions and the resultant glass-ceramic articles may be substantially free or free of individual tramp materials, a combination of tramp materials, or all tramp materials. For example, in embodiments, the precursor glass compositions and the resultant glass-ceramic articles may be substantially free or free of TiO₂, MnO, MoO₃, WO₃, CdO, As₂O₃, Sb₂O₃, sulfur-based compounds, such as sulfates, halogens, or combinations thereof.

In embodiments, antimicrobial components, chemical fining agents, or other additional components may be included in the precursor glass compositions and the resultant glass-ceramic articles.

In embodiments, a liquidus temperature of a precursor glass composition may be greater than or equal to 900° C. or even greater than or equal to 1000° C. In embodiments, a liquidus temperature of the precursor glass composition may be less than or equal to 1200° C. or even less than or equal to 1100° C. In embodiments, a liquidus temperature of the precursor glass composition may be greater than or equal to 900° C. and less than or equal to 1200° C., greater than or equal to 900° C. and less than or equal to 1100° C., greater than or equal to 1000° C. and less than or equal to 1200° C., or even greater than or equal to 1000° C. and less than or equal to 1100° C., or any and all sub-ranges formed from any of these endpoints.

The precursor glass articles or the glass-ceramic articles formed therefrom as described herein may be any suitable thickness, which may vary depending on the particular application of the glass-ceramic article. In embodiments, the precursor glass articles and the glass-ceramic articles formed therefrom may have a thickness greater than or equal to 250 μm and less than or equal to 6 mm, greater than or equal to 250 μm and less than or equal to 4 mm, greater than or equal to 250 μm and less than or equal to 2 mm, greater than or equal to 250 μm and less than or equal to 1 mm, greater than or equal to 250 μm and less than or equal to 750 μm, greater than or equal to 250 μm and less than or equal to 500 μm, greater than or equal to 500 μm and less than or equal to 6 mm, greater than or equal to 500 μm and less than or equal to 4 mm, greater than or equal to 500 μm and less than or equal to 2 mm, greater than or equal to 500 μm and less than or equal to 1 mm, greater than or equal to 500 μm and less than or equal to 750 μm, greater than or equal to 750 μm and less than or equal to 6 mm, greater than or equal to 750 μm and less than or equal to 4 mm, greater than or equal to 750 μm and less than or equal to 2 mm, greater than or equal to 750 μm and less than or equal to 1 mm, greater than or equal to 1 mm and less than or equal to 6 mm, greater than or equal to 1 mm and less than or equal to 4 mm, greater than or equal to 1 mm and less than or equal to 2 mm, greater than or equal to 2 mm and less than or equal to 6 mm, greater than or equal to 2 mm and less than or equal to 4 mm, or even greater than or equal to 4 mm and less than or equal to 6 mm, or any and all sub-ranges formed from any of these endpoints.

As discussed hereinabove, glass-ceramic articles formed from the precursor glass compositions described herein may have an increased fracture toughness such that the glass-ceramic articles are more resistant to damage. In embodiments, the glass-ceramic article may have a K_{Ic} fracture toughness as measured by a chevron notched short bar method greater than or equal to 1.0 MPa·m^{1/2}. In embodiments, the glass-ceramic article may have a K_{Ic} fracture toughness as measured by a chevron notched short bar method greater than or equal to 1.0 MPa·m^{1/2}, greater than or equal to 1.1 MPa·m^{1/2}, or even greater than or equal to 1.2 MPa·m^{1/2}.

In embodiments, an elastic modulus of a glass-ceramic article may be greater than or equal to 90 GPa. In embodiments, an elastic modulus of the glass-ceramic article may be greater than or equal to 90 GPa or even greater than or equal to 100 GPa. In embodiments, an elastic modulus of the glass-ceramic article may be less than or equal to 125 GPa or even less than or equal to 115 GPa. In embodiments, an elastic modulus of the glass-ceramic article may be greater than or equal to 90 GPa and less than or equal to 125 GPa, greater than or equal to 90 GPa and less than or equal to 115 GPa, greater than or equal to 100 GPa and less than or equal to 125 GPa, or even greater than or equal to 100 GPa and less than or equal to 115 GPa, or any and all sub-ranges formed from any of these endpoints.

In embodiments, a shear modulus of a glass-ceramic article may be greater than or equal to 30 GPa or even greater than or equal to 40 GPa. In embodiments, a shear modulus of a glass-ceramic article may be less than or equal to 55 GPa or even less than or equal to 45 GPa. In embodiments, a shear modulus of a glass-ceramic article may be greater than or equal to 30 GPa and less than or equal to 55 GPa, greater than or equal to 30 GPa and less than or equal to 45 GPa, greater than or equal to 40 GPa and less than or equal to 55 GPa, or even greater than or equal to 40 GPa and less than or equal to 45 GPa, or any and all sub-ranges formed from any of these endpoints.

In embodiments, an average transmittance of a glass-ceramic article may be greater than or equal to 50% and less than or equal to 95% of light over the wavelength range of 400 nm to 800 nm as measured at an article thickness of 0.8 mm. In embodiments, an average transmittance of the glass-ceramic article may be greater than or equal to 50%, greater than or equal to 60%, greater than or equal to 70%, or even greater than or equal to 80% of light over the wavelength range of 400 nm to 800 nm as measured at an article thickness of 0.8 mm. In embodiments, an average transmittance of the glass-ceramic article may be less than or equal to 95% or even less than or equal to 90% of light over the wavelength range of 400 nm to 800 nm as measured at an article thickness of 0.8 mm. In embodiments, an average transmittance of the glass-ceramic article may be greater than or equal to 50% and less than or equal to 95%, greater than or equal to 50% and less than or equal to 90%, greater than or equal to 60% and less than or equal to 95%, greater than or equal to 60% and less than or equal to 90%, greater than or equal to 70% and less than or equal to 95%, greater than or equal to 70% and less than or equal to 90%, greater than or equal to 80% and less than or equal to 95%, or even greater than or equal to 80% and less than or equal to 90%, or any and all sub-ranges formed from any of these endpoints of light over the wavelength range of 400 nm to 800 nm as measured at an article thickness of 0.8 mm. In embodiments, the glass-ceramic article may be transparent or transparent haze.

In embodiments, a Poisson's ratio of a glass-ceramic article may be greater than or equal to 0.17 or even greater than or equal to 0.19. In embodiments, a Poisson's ratio of the glass-ceramic article may be less than or equal to 0.23 or even less than or equal to 0.21. In embodiments, a Poisson's ratio of the glass-ceramic article may be greater than or equal to 0.17 and less than or equal to 0.23, greater than or equal to 0.17 and less than or equal to 0.21, greater than or equal to 0.19 and less than or equal to 0.23, or even greater than or equal to 0.19 and less than or equal to 0.21, or any and all sub-ranges formed from any of these endpoints.

In embodiments, a SOC of a glass-ceramic article may be greater than or equal to 2.5 nm/mm/MPa or even greater than or equal to 2.4 nm/mm/MPa. In embodiments, a SOC of the glass-ceramic article may be less than or equal to 2.8 nm/mm/MPa or even less than or equal to 2.7 nm/mm/MPa. In embodiments, a SOC of the glass-ceramic article may be greater than or equal to 2.4 nm/mm/MPa and less than or equal to 2.8 nm/mm/MPa, greater than or equal to 2.4 nm/mm/MPa and less than or equal to 2.7 nm/mm/MPa, greater than or equal to 2.5 nm/mm/MPa and less than or equal to 2.8 nm/mm/MPa, or even greater than or equal to 2.5 nm/mm/MPa and less than or equal to 2.7 nm/mm/MPa, or any and all sub-ranges formed from any of these endpoints.

In embodiments, the glass-ceramic articles described herein are ion exchangeable to strengthen the article. In typical ion exchange processes, smaller metal ions in the glass-ceramic article are replaced or “exchanged” with larger metal ions of the same valence within a layer that is close to the outer surface of the glass-ceramic article. The replacement of smaller ions with larger ions creates a compressive stress within the layer of the glass-ceramic article. In embodiments, the metal ions are monovalent metal ions (e.g., Li⁺, Na⁺, K⁺, and the like), and ion exchange is accomplished by immersing the glass-ceramic article in a bath comprising at least one molten salt of the larger metal ion that is to replace the smaller metal ion in the glass-ceramic article. Alternatively, other monovalent ions such as Ag⁺, Tl⁺, Cu⁺, and the like may be exchanged for monovalent ions. The ion exchange process or processes that are used to strengthen the glass-ceramic article may include, but are not limited to, immersion in a single bath or multiple baths of like or different compositions with optional washing and/or annealing steps between immersions.

Upon exposure to the glass-ceramic article, the ion exchange solution (e.g., KNO₃ and/or NaNO₃ molten salt bath that may also contain LiNO₃) may, according to embodiments, be at a temperature greater than or equal to 350° C. and less than or equal to 500° C., greater than or equal to 360° C. and less than or equal to 450° C., greater than or equal to 370° C. and less than or equal to 440° C., greater than or equal to 360° C. and less than or equal to 420° C., greater than or equal to 370° C. and less than or equal to 400° C., greater than or equal to 375° C. and less than or equal to 475° C., greater than or equal to 400° C. and less than or equal to 500° C., greater than or equal to 410° C. and less than or equal to 490° C., greater than or equal to 420° C. and less than or equal to 480° C., greater than or equal to 430° C. and less than or equal to 470° C., or even greater than or equal to 440° C. and less than or equal to 460° C., or any and all sub-ranges between the foregoing values. In embodiments, the glass-ceramic article may be exposed to the ion exchange solution for a duration greater than or equal to 2 hours and less than or equal to 24 hours, greater than or equal to 2 hours and less than or equal to 12 hours, greater than or equal to 2 hours and less than or equal to 6 hours, greater than or equal to 8 hours and less than or equal to 24 hours, greater than or equal to 6 hours and less than or equal to 24 hours, greater than or equal to 6 hours and less than or equal to 12 hours, greater than or equal to 8 hours and less than or equal to 24 hours, or even greater than or equal to 8 hours and less than or equal to 12 hours, or any and all sub-ranges formed from any of these endpoints.

The resulting compressive stress layer may have a depth (also referred to as a “depth of compression” or “DOC”) greater than or equal to 100 μm on the surface of the glass-ceramic article in 2 hours of ion exchange time. In embodiments, the glass-ceramic articles may be ion exchanged to achieve a depth of compression greater than or equal to 10 μm, greater than or equal to 20 μm, greater than or equal to 30 μm, greater than or equal to 40 μm, greater than or equal to 50 μm, greater than or equal to 60 μm, greater than or equal to 70 μm, greater than or equal to 80 μm, greater than or equal to 90 μm, or even greater than or equal to 100 μm. In embodiments, the glass-ceramic articles have a thickness “t” and may be ion exchanged to achieve a depth of compression greater than or equal to 0.25 t, greater than or equal to 0.27 t, or even greater than or equal to 0.30 t.

The development of this surface compression layer is beneficial for achieving a better crack resistance and higher flexural strength compared to non-ion exchanged materials. The surface compression layer has a higher concentration of the ions exchanged into the glass-ceramic article in comparison to the concentration of the ions exchanged into the body (i.e., the area not including the surface compression) of the glass-ceramic article.

In embodiments, the glass-ceramic article made from a precursor glass composition described herein may have a surface compressive stress after ion exchange strengthening greater than or equal to 80 MPa, greater than or equal to 100 MPa, or even greater than or equal to 250 MPa. In embodiments, the glass-ceramic article may have a surface compressive stress after ion exchange strengthening less than or equal to 1 GPa, less than or equal to 750 MPa, or even less than or equal to 500 MPa. In embodiments, the glass-ceramic article may have a surface compressive stress after ion exchange strengthening greater than or equal to 80 MPa and less than or equal to 1 GPa, greater than or equal to 80 MPa and less than or equal to 750 MPa, greater than or equal to 80 MPa and less than or equal to 500 MPa, greater than or equal to 100 MPa and less than or equal to 1 GPa, greater than or equal to 100 MPa and less than or equal to 750 MPa, greater than or equal to 100 MPa and less than or equal to 500 MPa, greater than or equal to 250 MPa and less than or equal to 1 GPa, greater than or equal to 250 MPa and less than or equal to 750 MPa, or even greater than or equal to 250 MPa and less than or equal to 500 MPa, or any and all sub-ranges formed from any of these endpoints.

As described herein, including alkaline earth oxides and/or transition metal oxides in the precursor glass composition may increase the maximum central tension of the resulting glass-ceramic article. In embodiments, the glass-ceramic article made from a precursor glass composition described herein may have a central tension after ion exchange strengthening greater than or equal to 30 MPa, greater than or equal to 50 MPa, or even greater than or equal to 100 MPa. In embodiments, the glass-ceramic article made from a precursor glass composition described herein may have a central tension after ion exchange strengthening less than or equal to 250 MPa, less than or equal to 200 MPa, or even less than or equal to 175 MPa. In embodiments, the glass-ceramic article made from a precursor glass composition described herein may have a central tension after ion exchange strengthening greater than or equal to 30 MPa and less than or equal to 250 MPa, greater than or equal to 30 MPa and less than or equal to 200 MPa, greater than or equal to 30 MPa and less than or equal to 175 MPa, greater than or equal to 50 MPa and less than or equal to 250 MPa, greater than or equal to 50 MPa and less than or equal to 200 MPa, greater than or equal to 50 MPa and less than or equal to 175 MPa, greater than or equal to 100 MPa and less than or equal to 250 MPa, greater than or equal to 100 MPa and less than or equal to 200 MPa, or even greater than or equal to 100 MPa and less than or equal to 175 MPa, or any and all sub-ranges formed from any of these endpoints.

In embodiments, the glass-ceramic article may have a depth of sodium ion penetration after ion exchange (also referred to as the chemical depth) greater than or equal to 0.025 t, greater than or equal to 0.1 t, or even greater than or equal to 0.2 t. In embodiments, the glass-ceramic article may have a depth of sodium ion penetration less than or equal to 0.28 t or even less than or equal to 0.25 t. In embodiments, the glass-ceramic article may have a depth of sodium ion penetration may be greater than or equal to 0.025 t and less than or equal to 0.28 t, greater than or equal to 0.025 t and less than or equal to 0.25 t, greater than or equal to 0.1 t and less than or equal to 0.28 t, greater than or equal to 0.1 t and less than or equal to 0.25 t, greater than or equal to 0.2 t and less than or equal to 0.28 t, or even greater than or equal to 0.2 t and less than or equal to 0.25 t, or any and all sub-ranges formed from any of these endpoints.

In embodiments, the glass-ceramic article may have a depth of potassium ion penetration after ion exchange greater than or equal to 0 t and less than or equal to 0.01 t.

In embodiments, the processes for making the glass-ceramic article includes heat treating a precursor glass article formed from a precursor glass composition in an oven at one or more preselected temperatures for one or more preselected times to induce glass homogenization and crystallization (i.e., nucleation and growth) of one or more crystalline phases (e.g., having one or more compositions, amounts, morphologies, sizes or size distributions, etc.). In embodiments, the heat treatment may include (i) heating a precursor glass article in an oven at a rate greater than or equal to 1° C./min and less than or equal to 10 ° C./min to a nucleation temperature; (ii) maintaining the precursor glass article at the nucleation temperature in the oven for time greater than or equal to 0.1 hour and less than or equal to 8 hours to produce a nucleated crystallizable glass; (iii) heating the nucleated crystallizable glass article in the oven at a rate greater than or equal to 1° C./min and less than or equal to 10° C./min to a crystallization temperature; (iv) maintaining the nucleated crystallizable glass article at the crystallization temperature in the oven for a time greater than or equal to 0.1 hour and less than or equal to 8 hours to produce the glass-ceramic article; and (v) cooling the glass-ceramic article to room temperature.

In embodiments, the nucleation temperature may be greater than or equal to 600° C. and less than or equal to 900° C. In embodiments, the nucleation temperature may be greater than or equal to 600° C. or even greater than or equal to 650° C. In embodiments, the nucleation temperature may be less than or equal to 900° C. or even less than or equal to 800° C. In embodiments, the nucleation temperature may be greater than or equal to 600° C. and less than or equal to 900° C., greater than or equal to 600° C. and less than or equal to 800° C., greater than or equal to 650° C. and less than or equal to 900° C., or even greater than or equal to 650° C. and less than or equal to 800° C., or any and all sub-ranges formed from any of these endpoints.

In embodiments, the crystallization temperature may be greater than or equal to 700° C. and less than or equal to 1000° C. In embodiments, the crystallization temperature may be greater than or equal to 700° C. or even greater than or equal to 750° C. In embodiments, the crystallization temperature may be less than or equal to 1000° C. or even less than or equal to 900° C. In embodiments, the crystallization temperature may be greater than or equal to 700° C. and less than or equal to 1000° C., greater than or equal to 700° C. and less than or equal to 900° C., greater than or equal to 750° C. and less than or equal to 1000° C., or even greater than or equal to 750° C. and less than or equal to 900° C., or any and all sub-ranges formed from any of these endpoints.

As utilized herein, the heating rates, nucleation temperature, and crystallization temperature refer to the heating rate and temperature of the oven in which the precursor glass composition or precursor glass article is being heat treated.

In addition to the precursor glass compositions, temperature-temporal profiles of heat treatment steps of heating to the crystallization temperature and maintaining the temperature at the crystallization temperature are judiciously prescribed so as to produce one or more of the following desired attributes: crystalline phase(s) of the glass-ceramic article, proportions of one or more major crystalline phases and/or one or more minor crystalline phases and residual glass phases, crystal phase assemblages of one or more predominate crystalline phases and/or one or more minor crystalline phases and residual glass phases, and grain sizes or grain size distribution among one or more major crystalline phases and/or one or more minor crystalline phases, which in turn may influence the final integrity, quality, color, and/or opacity of the resulting glass-ceramic article.

The glass-ceramic articles described herein include a crystalline phase and a residual glass phase. In embodiments, the crystalline phase may comprise lithium disilicate and petalite. Lithium disilicate, Li₂Si₂O₅, is an orthorhombic crystal based on corrugated sheets of {Si₂O₅} tetrahedral arrays. The crystals are typically tabular or lath-like in shape, with pronounced cleavage planes. Petalite, Li₂O.Al₂O₃.8 SiO₂, is a monoclinic crystal based on a three-dimensional framework structure of AlO₄ and SiO₄ tetrahedra, which contains Si₄O₁₀ layers linked by AlO₄ tetrahedra. Glass-ceramic articles based on lithium disilicate and petalite offer highly desirable mechanical properties, including high body strength and fracture toughness, due to their microstructures of randomly-oriented interlocked crystals—a crystal structure that forces cracks to propagate through the material via tortuous paths around these crystals.

In embodiments, the total amount of lithium disilicate and petalite in the crystalline phase, based on a total weight of the crystalline phase, may be greater than or equal to 50 wt %, greater than or equal to 60 wt %, or even greater than or equal to 70 wt %. In embodiments, the total amount of lithium disilicate and petalite in the crystalline phase, based on a total weight of the crystalline phase, may be less than or equal to 99 wt %, less than or equal to 90 wt %, or even less than or equal to 85 wt %. In embodiments, the total amount of lithium disilicate and petalite in the crystalline phase, based on a total weight of the crystalline phase, may be greater than or equal to 50 wt % and less than or equal to 99 wt %, greater than or equal to 50 wt % and less than or equal to 90 wt %, greater than or equal to 50 wt % and less than or equal to 85 wt %, greater than or equal to 60 wt % and less than or equal to 99 wt %, greater than or equal to 60 wt % and less than or equal to 90 wt %, greater than or equal to 60 wt % and less than or equal to 85 wt %, greater than or equal to 70 wt % and less than or equal to 99 wt %, greater than or equal to 70 wt % and less than or equal to 90 wt %, or even greater than or equal to 70 wt % and less than or equal to 85 wt %, or any and all sub-ranges formed from any of these endpoints.

In embodiments, the amount of lithium disilicate in crystalline phase, based on a total weight of the crystalline phase, may be greater than or equal to 20 wt % or even greater than or equal to 30 wt % lithium disilicate. In embodiments, the amount of lithium disilicate in the crystalline phase, based on a total weight of the crystalline phase, may be less than or equal to 60 wt % or even less than or equal to 50 wt %. In embodiments, the amount of lithium disilicate in crystalline phase, based on a total weight of the crystalline phase, may be greater than or equal to 20 wt % and less than or equal to 60 wt %, greater than or equal to 20 wt % and less than or equal to 50 wt %, greater than or equal to 30 wt % and less than or equal to 60 wt %, or even greater than or equal to 30 wt % and less than or equal to 50 wt %, or any and all sub-ranges formed from any of these endpoints.

In embodiments, the amount of petalite in crystalline phase, based on a total weight of the crystalline phase, may be greater than or equal to 20 wt % or even greater than or equal to 30 wt % lithium disilicate. In embodiments, the amount of petalite in the crystalline phase, based on a total weight of the crystalline phase, may be less than or equal to 60 wt % or even less than or equal to 50 wt %. In embodiments, the amount of petalite in crystalline phase, based on a total weight of the crystalline phase, may be greater than or equal to 20 wt % and less than or equal to 60 wt %, greater than or equal to 20 wt % and less than or equal to 50 wt %, greater than or equal to 30 wt % and less than or equal to 60 wt %, or even greater than or equal to 30 wt % and less than or equal to 50 wt %, or any and all sub-ranges formed from any of these endpoints.

In embodiments, in addition to lithium disilicate and petalite, the crystalline phase of the glass-ceramic article may further comprise lithium metasilicate, β-quartz, cristobalite, or combinations thereof.

In embodiments, the grain size of the grains of lithium disilicate and petalite of the crystalline phase may be limited (e.g., less than or equal to 100 nm) such that the glass-ceramic article is transparent or transparent haze. In embodiments, the grains of lithium disilicate and petalite of the crystalline phase may comprise a grain size greater than or equal to 10 nm, greater than or equal to 25 nm, or even greater than or equal to 50 nm. In embodiments, the grains of lithium disilicate and petalite of the crystalline phase may comprise a grain size less than or equal to 100 nm or even less than or equal to 75 nm. In embodiments, the grains of lithium disilicate and petalite of the crystalline phase may comprise a grain size greater than or equal to 10 nm and less than or equal to 100 nm, greater than or equal to 10 nm and less than or equal to 75 nm, greater than or equal to 25 nm and less than or equal to 100 nm, greater than or equal to 25 nm and less than or equal to 75 nm, greater than or equal to 50 nm and less than or equal to 100 nm, or even greater than or equal to 50 nm and less than or equal to 75 nm, or any and all sub-ranges formed from any of these endpoints.

In embodiments, the grains of lithium disilicate and petalite of the crystalline phase may comprise an aspect ratio greater than or equal to 2:1, greater than or equal to 5:1, greater than or equal to 10:1, greater than or equal to 20:1, or even greater than or equal to 25:1.

In embodiments, the glass-ceramic articles may include greater than or equal to 50 wt % of the crystalline phase by weight of the glass-ceramic article (i.e., wt %) and less than or equal to 50 wt % of the residual glass phase, greater than or equal to 60 wt % of the crystalline phase and less than or equal to 40 wt % of the residual glass phase, greater than or equal to 70 wt % of the crystalline phase and less than or equal to 30 wt % of the residual glass phase, greater than or equal to 80 wt % of the crystalline phase and less than or equal to 20 wt % of the residual glass phase, or even greater than or equal to 90 wt % of the crystalline phase and less than or equal to 10 wt %, or any and all sub-ranges formed from any of these endpoints as determined according to Rietveld analysis of the XRD spectrum.

The glass-ceramic article may be provided as a sheet, which may then be reformed by pressing, blowing, bending, sagging, vacuum forming, or other means into curved or bent pieces of uniform thickness.

The glass-ceramic articles described herein may be used for a variety of applications including, for example, for cover glass or glass backplane applications in consumer or commercial electronic devices including, for example, LCD and LED displays, computer monitors, and automated teller machines (ATMs); for touch screen or touch sensor applications, for portable electronic devices including, for example, mobile telephones, personal media players, watches and tablet computers; for integrated circuit applications including, for example, semiconductor wafers; for photovoltaic applications; for architectural glass applications; for automotive or vehicular glass applications; or for commercial or household appliance applications. In embodiments, a consumer electronic device (e.g., smartphones, tablet computers, watches, personal computers, ultrabooks, televisions, and cameras), an architectural glass, and/or an automotive glass may comprise a glass-article article as described herein.

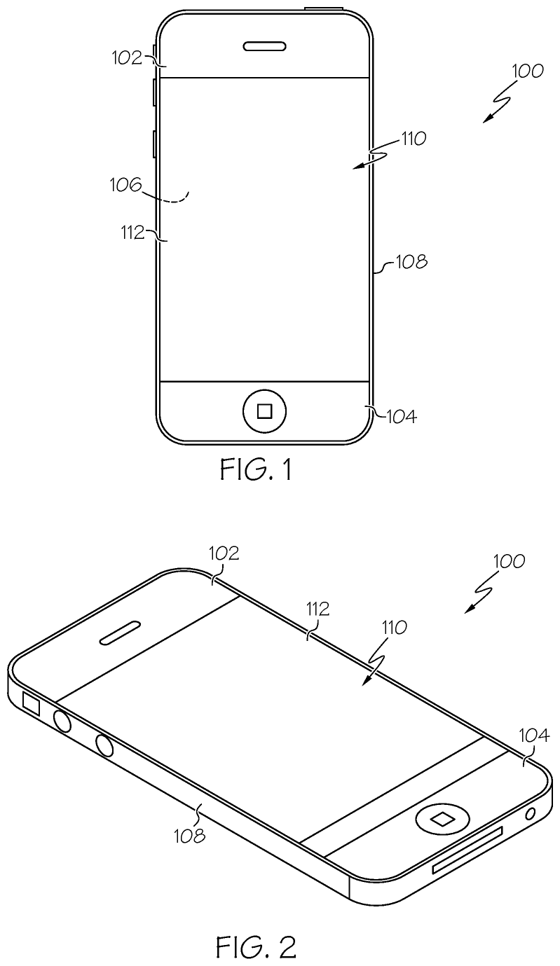

An exemplary electronic device incorporating any of the glass-ceramic articles disclosed herein is shown in FIGS. 1 and 2. Specifically, FIGS. 1 and 2 show a consumer electronic device 100 including a housing 102 having front 104, back 106, and side surfaces 108; electrical components (not shown) that are at least partially inside or entirely within the housing and including at least a controller, a memory, and a display 110 at or adjacent to the front surface of the housing; and a cover substrate 112 at or over the front surface of the housing such that it is over the display. In embodiments, at least a portion of at least one of the cover substrate 112 and the housing 102 may include any of the glass-ceramic articles disclosed herein.

### EXAMPLES

In order that various embodiments be more readily understood, reference is made to the following examples, which are intended to illustrate various embodiments of the precursor glass compositions and glass-ceramic articles described herein.

Table 1 shows example and comparative precursor glass compositions (in terms of mol %) and the liquidus temperatures of the precursor glass compositions. Table 2 shows the heat treatment schedule for achieving example and comparative glass-ceramic articles, and the respective properties of the glass-ceramic articles. Glass-ceramic articles were formed having the example precursor glass compositions 1-29 and comparative precursor glass compositions C1-C9 listed in Table 1.

TABLE 1

| Example | 1 | 2 | 3 | 4 | 5 | 6 |
|---|---|---|---|---|---|---|
| SiO₂ | 68.2 | 67.6 | 67.6 | 68.2 | 67.6 | 66.9 |
| B₂O₃ | — | — | — | — | — | — |
| Al₂O₃ | 3.7 | 3.6 | 3.6 | 3.7 | 3.6 | 3.6 |
| Li₂O | 21.3 | 21.1 | 21.1 | 21.3 | 21.1 | 20.9 |
| Na₂O | 1.2 | 1.1 | 1.1 | 1.2 | 1.1 | 1.1 |
| K₂O | 0.7 | 0.7 | 0.7 | 0.7 | 0.7 | 0.7 |
| MgO | — | — | — | 1.0 | 1.9 | 2.8 |
| CaO | — | 1.9 | — | — | — | — |
| SrO | — | — | — | — | — | — |
| BaO | — | — | 1.9 | — | — | — |
| ZnO | — | — | — | — | — | — |
| GeO₂ | — | — | — | — | — | — |
| La₂O₃ | 1.0 | — | — | — | — | — |
| Y₂O₃ | — | — | — | — | — | — |
| Ta₂O₃ | — | — | — | — | — | — |
| P₂O₅ | 1.0 | 1.0 | 1.0 | 1.0 | 1.0 | 0.9 |
| ZrO₂ | 2.9 | 2.9 | 2.9 | 2.9 | 2.9 | 2.8 |
| SnO₂ | 0.1 | 0.1 | 0.1 | 0.1 | 0.1 | 0.1 |
| R₂O | 23.2 | 22.9 | 22.9 | 23.2 | 22.9 | 22.7 |
| RO | 0 | 1.9 | 1.9 | 1.0 | 1.9 | 2.8 |
| Alkaline earth | 0 | 1.9 | 1.9 | 1.0 | 1.9 | 2.8 |
| oxides | | | | | | |
| Transition metal | 1.0 | 0 | 0 | 0 | 0 | 0 |
| oxides | | | | | | |
| Alkaline earth | 1.0 | 1.9 | 1.9 | 1.0 | 1.9 | 2.8 |
| oxides + | | | | | | |
| transition | | | | | | |
| metal oxides | | | | | | |
| P₂O₅ + ZrO₂ | 3.9 | 3.9 | 3.9 | 3.9 | 3.9 | 3.7 |
| Li₂O/Al₂O₃ | 5.76 | 5.86 | 5.86 | 5.76 | 5.86 | 5.81 |
| Li₂O/SiO₂ | 0.31 | 0.31 | 0.31 | 0.31 | 0.31 | 0.31 |
| (SiO₂ + Al₂O₃)/ | 18.44 | 18.26 | 18.26 | 18.44 | 18.26 | 19.05 |
| (P₂O₅ + ZrO₂) | | | | | | |
| Liquidus temp. | 1055 | 1055 | 1015 | 1040 | 1055 | 1065 |
| (° C.) | | | | | | |
| Example | 7 | 8 | 9 | 10 | 11 | 12 |
| SiO₂ | 66.3 | 68.2 | 66.9 | 66.3 | 68.2 | 67.6 |
| B₂O₃ | — | — | — | — | — | — |
| Al₂O₃ | 3.6 | 3.7 | 3.6 | 3.6 | 3.7 | 3.6 |
| Li₂O | 20.7 | 21.3 | 20.9 | 20.7 | 21.3 | 21.1 |
| Na₂O | 1.1 | 1.2 | 1.1 | 1.1 | 1.2 | 1.1 |
| K₂O | 0.7 | 0.7 | 0.7 | 0.7 | 0.7 | 0.7 |
| MgO | 3.8 | — | — | — | — | — |
| CaO | — | 1.0 | 2.8 | 3.8 | — | — |
| SrO | — | — | — | — | 1.0 | 1.9 |
| BaO | — | — | — | — | — | — |
| ZnO | — | — | — | — | — | — |
| GeO₂ | — | — | — | — | — | — |
| La₂O₃ | — | — | — | — | — | — |
| Y₂O₃ | — | — | — | — | — | — |
| Ta₂O₅ | — | — | — | — | — | — |
| P₂O₅ | 0.9 | 1.0 | 0.9 | 0.9 | 1.0 | 1.0 |
| ZrO₂ | 2.8 | 2.9 | 2.8 | 2.8 | 2.9 | 2.9 |
| SnO₂ | 0.1 | 0.1 | 0.1 | 0.1 | 0.1 | 0.1 |
| R₂O | 22.5 | 23.2 | 22.7 | 22.5 | 23.2 | 22.9 |
| RO | 3.8 | 1.0 | 2.8 | 3.8 | 1.0 | 1.9 |
| Alkaline earth | 3.8 | 1.0 | 2.8 | 3.8 | 1.0 | 1.9 |
| oxides | | | | | | |
| Transition metal | 0 | 0 | 0 | 0 | 0 | 0 |
| oxides | | | | | | |
| Alkaline earth | 3.8 | 1.0 | 2.8 | 3.8 | 1.0 | 1.9 |
| oxides + | | | | | | |
| transition | | | | | | |
| metal oxides | | | | | | |
| P₂O₅ + ZrO₂ | 3.7 | 3.9 | 3.7 | 3.7 | 3.9 | 3.9 |
| Li₂O/Al₂O₃ | 5.75 | 5.76 | 5.81 | 5.75 | 5.76 | 5.86 |
| Li₂O/SiO₂ | 0.31 | 0.31 | 0.31 | 0.31 | 0.31 | 0.31 |
| (SiO₂ + Al₂O₃)/ | 18.89 | 18.44 | 19.05 | 18.89 | 18.44 | 18.26 |
| (P₂O₅ + ZrO₂) | | | | | | |
| Liquidus temp. | 1080 | 1040 | 1040 | 1040 | 1035 | 1020 |
| (° C.) | | | | | | |
| Example | 13 | 14 | 15 | 16 | 17 | 18 |
| SiO₂ | 66.9 | 66.3 | 68.2 | 68.9 | 68.9 | 68.9 |
| B₂O₃ | — | — | — | — | — | — |
| Al₂O₃ | 3.6 | 3.6 | 3.7 | 2.7 | 2.7 | 2.7 |
| Li₂O | 20.9 | 20.7 | 21.3 | 21.5 | 21.5 | 21.5 |
| Na₂O | 1.1 | 1.1 | 1.2 | 1.0 | 1.0 | 1.0 |
| K₂O | 0.7 | 0.7 | 0.7 | 0.7 | 0.7 | 0.7 |
| MgO | — | — | — | — | — | — |
| CaO | — | — | — | — | — | — |
| SrO | 2.8 | 3.8 | — | — | — | — |
| BaO | — | — | 1.0 | — | — | — |
| ZnO | — | — | — | — | — | — |
| GeO₂ | — | — | — | — | — | — |
| La₂O₃ | — | — | — | — | — | — |
| Y₂O₃ | — | — | — | 0.5 | 0.7 | 1.0 |
| Ta₂O₅ | — | — | — | — | — | — |
| P₂O_{S} | 0.9 | 0.9 | 1.0 | 1.2 | 1.2 | 1.2 |
| ZrO₂ | 2.8 | 2.8 | 2.9 | 3.4 | 3.2 | 2.9 |
| SnO₂ | 0.1 | 0.1 | 0.1 | 0.1 | 0.1 | 0.1 |
| R₂O | 22.7 | 22.5 | 23.2 | 23.2 | 23.2 | 23.2 |
| RO | 2.8 | 3.8 | 1.0 | 0 | 0 | 0 |
| Alkaline earth | 2.8 | 3.8 | 1.0 | 0 | 0 | 0 |
| oxides | | | | | | |
| Transition metal | 0 | 0 | 0 | 0.5 | 0.7 | 1.0 |
| oxides | | | | | | |
| Alkaline earth | 2.8 | 3.8 | 1.0 | 0.5 | 0.7 | 1.0 |
| oxides + | | | | | | |
| transition | | | | | | |
| metal oxides | | | | | | |
| P₂O₅ + ZrO₂ | 3.7 | 3.7 | 3.9 | 4.6 | 4.4 | 4.1 |
| Li₂O/Al₂O₃ | 5.81 | 5.75 | 5.76 | 7.96 | 7.96 | 7.96 |
| Li₂O/SiO₂ | 0.31 | 0.31 | 0.31 | 0.31 | 0.31 | 0.31 |
| (SiO₂ + Al₂O₃)/ | 19.05 | 18.89 | 18.44 | 15.57 | 16.27 | 17.46 |
| (P₂O₅ + ZrO₂) | | | | | | |
| Liquidus temp. | 1015 | 1045 | 1035 | 1040 | 1025 | 1025 |
| (° C.) | | | | | | |
| Example | 19 | 20 | 21 | 22 | 23 | 24 |
| SiO₂ | 70.1 | 69.8 | 70.1 | 69.8 | 70.1 | 69.8 |
| B₂O₃ | — | — | — | — | — | — |
| Al₂O₃ | 4.2 | 4.2 | 4.2 | 4.2 | 4.2 | 4.2 |
| Li₂O | 21.3 | 21.2 | 21.3 | 21.2 | 21.3 | 21.2 |
| Na₂O | 1.5 | 1.5 | 1.5 | 1.5 | 1.5 | 1.5 |
| K₂O | — | — | — | — | — | — |
| MgO | — | — | — | — | — | — |
| CaO | — | — | — | — | — | — |
| SrO | — | — | — | — | — | — |
| BaO | 0.2 | 0.7 | — | — | — | — |
| ZnO | — | — | — | — | — | — |
| GeO₂ | — | — | 0.2 | 0.7 | — | — |
| La₂O₃ | — | — | — | — | 0.2 | 0.7 |
| Y₂O₃ | — | — | — | — | — | — |
| Ta₂O₅ | — | — | — | — | — | — |
| P₂O₅ | 0.9 | 0.9 | 0.9 | 0.9 | 0.9 | 0.9 |
| ZrO₂ | 1.7 | 1.7 | 1.7 | 1.7 | 1.7 | 1.7 |
| SnO₂ | — | — | — | — | — | — |
| R₂O | 22.8 | 22.7 | 22.8 | 22.7 | 22.8 | 22.7 |
| RO | 0.2 | 0.7 | 0 | 0 | 0 | 0 |
| Alkaline earth | 0.2 | 0.7 | 0 | 0 | 0 | 0 |
| oxides | | | | | | |
| Transition metal | 0 | 0 | 0.2 | 0.7 | 0.2 | 0.7 |
| oxides | | | | | | |
| Alkaline earth | 0.2 | 0.7 | 0.2 | 0.7 | 0.2 | 0.7 |
| oxides + | | | | | | |
| transition | | | | | | |
| metal oxides | | | | | | |
| P₂O₅ + ZrO₂ | 2.6 | 2.6 | 2.6 | 2.6 | 2.6 | 2.6 |
| Li₂O/Al₂O₃ | 5.07 | 5.05 | 5.07 | 5.05 | 5.07 | 5.05 |
| Li₂O/SiO₂ | 0.30 | 0.30 | 0.30 | 0.30 | 0.30 | 0.30 |
| (SiO₂ + Al₂O₃)/ | 28.58 | 28.46 | 28.58 | 28.46 | 28.58 | 28.46 |
| (P₂O₅ + ZrO₂) | | | | | | |
| Liquidus temp. | — | — | — | — | — | — |
| (° C.) | | | | | | |

| Example | 25 | 26 | 27 | 28 | 29 | C1 |
|---|---|---|---|---|---|---|
| SiO₂ | 70.1 | 69.8 | 70.1 | 70.1 | 69.8 | 69.0 |
| B₂O₃ | — | — | — | — | — | — |
| Al₂O₃ | 4.3 | 4.3 | 4.3 | 4.3 | 4.3 | 3.7 |
| Li₂O | 22.5 | 22.4 | 22.5 | 22.5 | 22.4 | 21.6 |
| Na₂O | — | — | — | — | — | 1.0 |
| K₂O | — | — | — | — | — | 0.7 |
| MgO | — | — | — | — | — | — |
| CaO | — | — | — | — | — | — |
| SrO | — | — | 0.2 | — | — | — |
| BaO | 0.2 | 0.7 | — | — | — | — |
| ZnO | — | — | — | — | — | — |
| GeO₂ | — | — | — | — | — | — |
| La₂O₃ | — | — | — | — | — | — |
| Y₂O₃ | — | — | — | — | — | — |
| Ta₂O₅ | — | — | — | 0.2 | 0.7 | — |
| P₂O₅ | 0.8 | 0.8 | 0.8 | 0.8 | 0.8 | 1.0 |
| ZrO₂ | 2.0 | 2.0 | 2.0 | 2.0 | 2.0 | 2.9 |
| SnO₂ | — | — | — | — | — | 0.1 |
| R₂O | 22.5 | 22.4 | 22.5 | 22.5 | 22.4 | 23.3 |
| RO | 0.2 | 0.7 | 0.2 | 0 | 0 | 0 |
| Alkaline earth | 0.2 | 0.7 | 0.2 | 0 | 0 | 0 |
| oxides | | | | | | |
| Transition metal | 0 | 0 | 0 | 0.2 | 0.7 | 0 |
| oxides | | | | | | |
| Alkaline earth | 0.2 | 0.7 | 0.2 | 0.2 | 0.7 | 0 |
| oxides + | | | | | | |
| transition | | | | | | |
| metal oxides | | | | | | |
| P₂O₅ + ZrO₂ | 2.8 | 2.8 | 2.8 | 2.8 | 2.8 | 3.9 |
| Li₂O/Al₂O₃ | 5.23 | 5.21 | 5.23 | 5.23 | 5.21 | 5.84 |
| Li₂O/SiO₂ | 0.32 | 0.32 | 0.32 | 0.32 | 0.32 | 0.31 |
| (SiO₂ + Al₂O₃)/ | 26.57 | 26.46 | 26.57 | 26.57 | 26.46 | 18.64 |
| (P₂O₅ + ZrO₂) | | | | | | |
| Liquidus temp. | — | — | — | — | — | 1050 |
| (° C.) | | | | | | |

| Example | C2 | C3 | C4 | C5 | C6 | C7 |
|---|---|---|---|---|---|---|
| SiO₂ | 69.0 | 70.3 | 69.8 | 68.2 | 67.6 | 70.1 |
| B₂O₃ | — | — | — | — | — | — |
| Al₂O₃ | 2.7 | 4.3 | 4.3 | 3.7 | 3.6 | 4.2 |
| Li₂O | 21.6 | 22.6 | 22.4 | 21.3 | 21.1 | 21.3 |
| Na₂O | 1.0 | — | 2.0 | 1.2 | 1.1 | 1.5 |
| K₂O | 0.7 | — | — | 0.7 | 0.7 | — |
| MgO | — | — | — | — | — | — |
| CaO | — | — | — | — | — | — |
| SrO | — | — | — | — | — | — |
| BaO | — | — | — | — | — | — |
| ZnO | — | — | 0.7 | 1.0 | 1.9 | 0.2 |
| GeO₂ | — | — | — | — | — | — |
| La₂O₃ | — | — | — | — | — | — |
| Y₂O₃ | — | — | — | — | — | — |
| Ta₂O₃ | — | — | — | — | — | — |
| P₂O₅ | 1.0 | 0.8 | 0.8 | 1.0 | 1.0 | 0.9 |
| ZrO₂ | 3.9 | 2.0 | 2.0 | 2.9 | 2.9 | 1.7 |
| SnO₂ | 0.1 | 0.0 | — | 0.1 | 0.1 | — |
| R₂O | 23.3 | 22.6 | 24.4 | 23.2 | 22.9 | 22.8 |
| RO | 0 | 0 | 0.7 | 1.0 | 1.9 | 0.2 |
| Alkaline earth | 0 | 0 | 0 | 0 | 0 | 0 |
| oxides | | | | | | |
| Transition metal | 0 | 0 | 0 | 0 | 0 | 0 |
| oxides | | | | | | |
| Alkaline earth | 0 | 0 | 0 | 0 | 0 | 0 |
| oxides + | | | | | | |
| transition | | | | | | |
| metal oxides | | | | | | |
| P₂O₅ + ZrO₂ | 4.9 | 2.8 | 2.8 | 3.9 | 3.9 | 2.6 |
| Li₂O/Al₂O₃ | 8.00 | 5.26 | 5.21 | 5.76 | 5.86 | 5.07 |
| Li₂O/SiO₂ | 0.31 | 0.32 | 0.32 | 0.31 | 0.31 | 0.30 |
| (SiO₂ + Al₂O₃)/ | 14.63 | 26.64 | 26.46 | 18.44 | 18.26 | 28.58 |
| (P₂O₅ + ZrO₂) | | | | | | |
| Liquidus temp. | 1070 | — | — | 1055 | 1045 | — |
| (° C.) | | | | | | |

| Example | C8 | C9 |
|---|---|---|
| SiO₂ | 69.8 | 70.1 |
| B₂O₃ | — | — |
| Al₂O₃ | 4.2 | 4.3 |
| Li₂O | 21.2 | 22.5 |
| Na₂O | 1.5 | — |
| K₂O | — | — |
| MgO | — | — |
| CaO | — | — |
| SrO | — | — |
| BaO | — | — |
| ZnO | 0.7 | 0.2 |
| GeO₂ | — | — |
| La₂O₃ | — | — |
| Y₂O₃ | — | — |
| Ta₂O₃ | — | — |
| P₂O₅ | 0.9 | 0.8 |
| ZrO₂ | 1.7 | 2.0 |
| SnO₂ | — | — |
| R₂O | 22.7 | 22.5 |
| RO | 0.7 | 0.2 |
| Alkaline earth | 0 | 0 |
| oxides | | |
| Transition metal | 0 | 0 |
| oxides | | |
| Alkaline earth | 0 | 0 |
| oxides + | | |
| transition | | |
| metal oxides | | |
| P₂O₅ + ZrO₂ | 2.6 | 2.8 |
| Li₂O/Al₂O₃ | 5.05 | 5.23 |
| Li₂O/SiO₂ | 0.30 | 0.32 |
| (SiO₂ + Al₂O₃)/ | 28.46 | 26.57 |
| (P₂O₅ + ZrO₂) | | |
| Liquidus temp. | — | — |
| (° C.) | | |

TABLE 2

| Example | 1 | 2 | 3 | 4 | 5 |
|---|---|---|---|---|---|
| Nucleation hold | 580° C. for 4 hr | 560° C. for 4 hr | 560° C. for 4 hr | 580° C. for 4 hr | 560° C. for 4 hr |
| Crystallization | 750° C. for 1 hr | 730° C. for 1 hr | 730° C. for 1 hr | 750° C. for 1 hr | 730° C. for 1 hr |
| hold | | | | | |
| Appearance | Transparent | Transparent | Transparent | Transparent | Transparent |
| | haze | | | | |
| Phase assemblage | Lithium | Lithium | Lithium | Lithium | Lithium |
| | disilicate, | disilicate, | disilicate, | disilicate, | disilicate, |
| | Petalite | Petalite | Petalite | Petalite | Petalite |
| Elastic modulus | — | 102.7 | 100.7 | — | 102 |
| (Gpa) | | | | | |
| Shear modulus | — | 42.6 | 41.7 | — | 42.4 |
| (Gpa) | | | | | |
| Poisson's Ratio | — | 0.204 | 0.207 | — | 0.203 |
| K_{Ic} (CN) | — | 1.279 | 1.113 | — | 1.109 |
| (MPa · m^{1/2}) | | | | | |
| SOC | 2.626 | 2.616 | 2.568 | 2.645 | 2.601 |
| (nm/mm/MPa) | | | | | |
| Example | 6 | 7 | 8 | 9 | 10 |
| Nucleation hold | 560° C. for 4 hr | 560° C. for 4 hr | 580° C. for 4 hr | 580° C. for 4 hr | 560° C. for 4 hr |
| Crystallization | 710° C. for 1 hr | 710° C. for 1 hr | 750° C. for 1 hr | 750° C. for 1 hr | 730° C. for 1 hr |
| hold | | | | | |
| Appearance | Transparent | Transparent | Transparent | Transparent | Transparent |
| Phase assemblage | Lithium | Lithium | Lithium | Lithium | Lithium |
| | disilicate, | disilicate, | disilicate, | disilicate, | disilicate, |
| | Petalite | Petalite | Petalite | Petalite | Petalite |
| Elastic modulus | — | — | — | — | 102 |
| (Gpa) | | | | | |
| Shear modulus | — | — | — | — | 42.4 |
| (Gpa) | | | | | |
| Poisson's Ratio | — | — | — | — | 0.203 |
| K_{Ic} (CN) | — | — | — | — | 1.109 |
| (MPa · m^{1/2}) | | | | | |
| SOC | — | — | 2.633 | 2.645 | 2.601 |
| (nm/mm/MPa) | | | | | |
| Example | 11 | 12 | 13 | 14 | 15 |
| Nucleation hold | 560° C. for 4 hr | 560° C. for 4 hr | 580° C. for 4 hr | 560° C. for 4 hr | 580° C. for 4 hr |
| Crystallization | 710° C. for 1 hr | 710° C. for 1 hr | 750° C. for 1 hr | 710° C. for 1 hr | 750° C. for 1 hr |
| hold | | | | | |
| Appearance | Transparent | Transparent | Transparent | Transparent | Transparent |
| Phase assemblage | Lithium | Lithium | Lithium | Lithium | Lithium |
| | disilicate, | disilicate, | disilicate, | disilicate, | disilicate, |
| | Petalite | Petalite | Petalite | Petalite | Petalite |
| Elastic modulus | — | — | — | — | — |
| (Gpa) | | | | | |
| Shear modulus | — | — | — | — | — |
| (Gpa) | | | | | |
| Poisson's Ratio | — | — | — | — | — |
| K_{Ic} (CN) | — | — | — | — | — |
| (MPa · m^{1/2}) | | | | | |
| SOC | — | — | 2.633 | 2.528 | 2.616 |
| (nm/mm/MPa) | | | | | |
| Example | 16 | 17 | 18 | 19 | 20 |
| Nucleation hold | 600° C. for 4 hr | 600° C. for 4 hr | 600° C. for 4 hr | 560° C. for 4 hr | 560° C. for 4 hr |
| Crystallization | 740° C. for 1 hr | 740° C. for 1 hr | 740° C. for 1 hr | 720° C. for 1 hr | 720° C. for 1 hr |
| hold | | | | | |
| Appearance | Transparent | Transparent | Transparent | Transparent | Transparent |
| Phase assemblage | Lithium | Lithium | Lithium | Lithium | Lithium |
| | disilicate, | disilicate, | disilicate, | disilicate, | disilicate, |
| | Petalite | Petalite | Petalite | Petalite | Petalite |
| Elastic modulus | 99.8 | 100.1 | 100.3 | — | — |
| (Gpa) | | | | | |
| Shear modulus | 41.5 | 41.5 | 41.7 | — | — |
| (Gpa) | | | | | |
| Poisson's Ratio | 0.202 | 0.207 | 0.203 | — | — |
| K_{Ic} (CN) | 1.132 | 1.109 | 1.157 | — | — |
| (MPa · m^{1/2}) | | | | | |
| SOC | 2.677 | 2.654 | 2.638 | — | — |
| (nm/mm/MPa) | | | | | |
| Example | 21 | 22 | 23 | 24 | 25 |
| Nucleation hold | 560° C. for 4 hr | 560° C. for 4 hr | 560° C. for 4 hr | 560° C. for 4 hr | 580° C. for 4 hr |
| Crystallization | 720° C. for 1 hr | 720° C. for 1 hr | 720° C. for 1 hr | 720° C. for 1 hr | 760° C. for 1 hr |
| hold | | | | | |
| Appearance | Transparent | Transparent | Transparent | Transparent | Transparent |
| Phase assemblage | Lithium | Lithium | Lithium | Lithium | Lithium |
| | disilicate, | disilicate, | disilicate, | disilicate, | disilicate, |
| | Petalite | Petalite | Petalite | Petalite | Petalite |
| Elastic modulus | — | — | — | — | 104.2 |
| (Gpa) | | | | | |
| Shear modulus | — | — | — | — | 43.6 |
| (Gpa) | | | | | |
| Poisson's Ratio | — | — | — | — | 0.195 |
| K_{Ic} (CN) | — | — | — | — | — |
| (MPa · m^{1/2}) | | | | | |
| SOC | — | — | — | — | 2.558 |
| (nm/mm/MPa) | | | | | |

| Example | 26 | 27 | 28 | 29 |
|---|---|---|---|---|
| Nucleation hold | 580° C. for 4 hr | 580° C. for 4 hr | 580° C. for 4 hr | 580° C. for 4 hr |
| Crystallization | 760° C. for 1 hr | 760° C. for 1 hr | 760° C. for 1 hr | 760° C. for 1 hr |
| hold | | | | |
| Appearance | Transparent | Transparent | Transparent | Transparent |
| | | | | haze |
| Phase assemblage | Lithium | Lithium | Lithium | Lithium |
| | disilicate, | disilicate, | disilicate, | disilicate, |
| | Petalite | Petalite | Petalite | Petalite, |
| | | | | Cristobalite |
| Elastic modulus | 104.3 | 104.3 | 104 | 104.1 |
| (Gpa) | | | | |
| Shear modulus | 43.6 | 43.6 | 43.5 | 43.6 |
| (Gpa) | | | | |
| Poisson's Ratio | 0.196 | 0.194 | 0.195 | 0.194 |
| K_{Ic} (CN) | — | — | — | — |
| (MPa · m^{1/2}) | | | | |
| SOC | 2.546 | 2.58 | 2.594 | 2.624 |
| (nm/mm/MPa) | | | | |

| Example | C1 | C2 | C3 | C4 | C5 |
|---|---|---|---|---|---|
| Nucleation hold | 580° C. for 4 hr | 580° C. for 4 hr | 580° C. for 4 hr | 580° C. for 4 hr | 580° C. for 4 hr |
| Crystallization | 750° C. for 1 hr | 750° C. for 1 hr | 760° C. for 1 hr | 760° C. for 1 hr | 750° C. for 1 hr |
| hold | | | | | |
| Appearance | Transparent | Transparent | Transparent | Transparent | Transparent |
| | | | | | haze |
| Phase assemblage | Lithium | Lithium | Lithium | Lithium | Lithium |
| | disilicate, | disilicate, | disilicate, | disilicate, | disilicate, |
| | Petalite | Petalite | Petalite | Petalite, | Petalite |
| | | | | Lithium | |
| | | | | metasilicate | |
| Elastic modulus | 101.2 | 100.5 | 103.8 | 104 | — |
| (Gpa) | | | | | |
| Shear modulus | 42.3 | 42 | 43.5 | 43.4 | — |
| (Gpa) | | | | | |
| Poisson's Ratio | 0.198 | 0.197 | 0.193 | 0.195 | — |
| K_{Ic} (CN) | 1.113 | 1.116 | — | — | — |
| (MPa · m^{1/2}) | | | | | |
| SOC | 2.664 | 2.707 | 2.576 | 2.602 | 2.684 |
| (nm/mm/MPa) | | | | | |

| Example | C6 | C7 | C8 | C9 |
|---|---|---|---|---|
| Nucleation hold | 560° C. for 4 hr | 560° C. for 4 hr | 560° C. for 4 hr | 580° C. for 4 hr |
| Crystallization | 730° C. for 1 hr | 720° C. for 1 hr | 720° C. for 1 hr | 760° C. for 1 hr |
| hold | | | | |
| Appearance | Transparent | Transparent | Transparent | Transparent |
| | haze | | | |
| Phase assemblage | Lithium | Lithium | Lithium | Lithium |
| | disilicate, | disilicate, | disilicate, | disilicate, |
| | Petalite | Petalite | Petalite | Petalite |
| Elastic modulus | — | — | — | 104 |
| (Gpa) | | | | |
| Shear modulus | — | — | — | 43.4 |
| (Gpa) | | | | |
| Poisson's Ratio | — | — | — | 0.197 |
| K_{Ic} (CN) | — | — | — | — |
| (MPa · m^{1/2}) | | | | |
| SOC | — | — | — | 2.594 |
| (nm/mm/MPa) | | | | |

As indicated by the example precursor glass compositions in Table 1 and the glass-ceramic articles in Table 2, the glass-ceramic articles formed form the precursor glass compositions described herein may be transparent or transparent haze, lithium disilicate and petalite glass-ceramic articles having improved fracture toughness and elastic modulus.

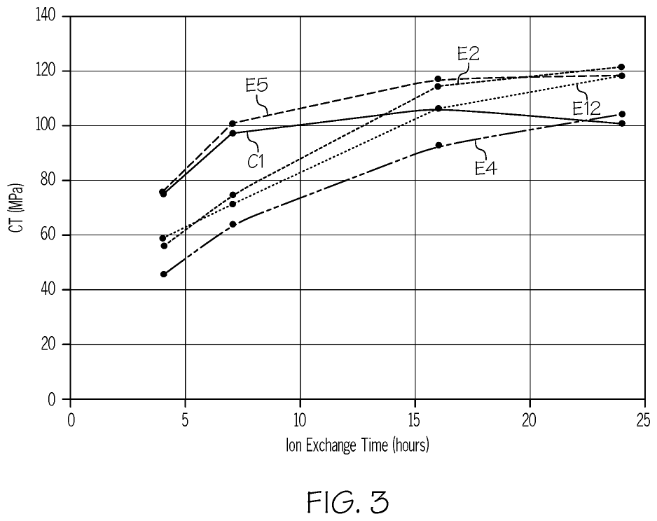

Referring now to FIG. 3, glass-ceramic articles formed from example precursor glass compositions 2, 3, 5, and 12 and comparative precursor glass composition C1 were subjected to a 100% NaNO₃ ion exchange bath at a temperature of 470° C. As shown in FIG. 3, the inclusion of MgO (example precursor glass composition 5 (E5)), CaO (example precursor glass composition 2 (E2)), SrO (example precursor glass composition 12 (E12)), and BaO (example precursor glass composition 3 (E3)) in the precursor glass compositions resulted in an increase in the maximum central tension of the example glass-ceramic articles as compared to the maximum central tension of the comparative glass-ceramic article formed from comparative precursor glass composition C1, which did not include any alkaline earth oxides or transition metal oxides.

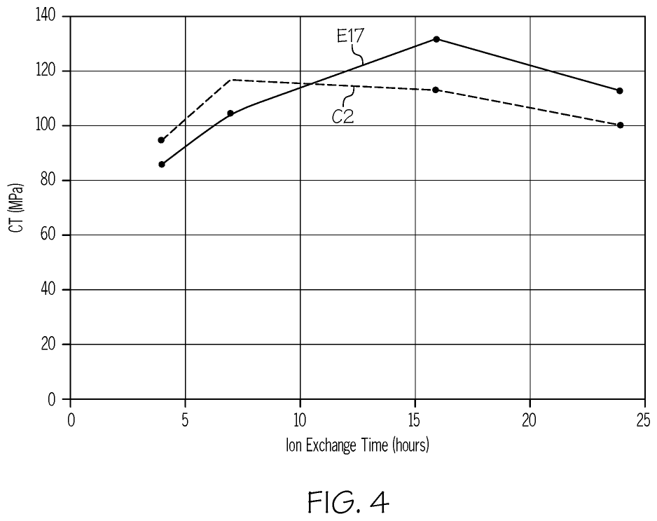

Referring now to FIG. 4, glass-ceramic articles formed from example precursor glass composition 17 and comparative precursor glass composition C2 were subjected to a 100% NaNO₃ ion exchange bath at a temperature of 470° C. As shown in FIG. 4, the inclusion of Y₂O₃ (example precursor glass composition 17 (E17)) in the precursor glass composition resulted in an increase in the maximum central tension of the example glass-ceramic article as compared to the maximum central tension of the comparative glass-ceramic article formed from comparative precursor glass composition C2, which did not include any Y₂O₃ or any other transition metal oxides or alkaline earth oxides.

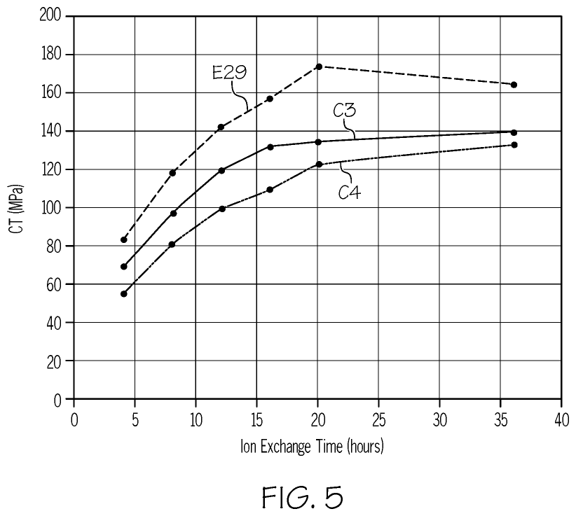

Referring now to FIG. 5, the glass-ceramic articles formed from example precursor glass composition 29 and comparative precursor glass compositions C3 and C4 were subjected to a 100% NaNO₃ ion exchange bath at a temperature of 470° C. As shown in FIG. 5, the inclusion of Ta₂O₅ (precursor glass composition 29 (E29)) in the precursor glass composition resulted in an increase in the maximum central tension of the example glass-ceramic article as compared to the maximum central tensions of the comparative glass-ceramic articles formed from comparative precursor glass compositions C3 and C4, which did not include any Ta₂O₅ or any other transition metal oxides or alkaline earth oxides.

As indicated by FIGS. 3-5, including alkaline earth oxides and/or transition metal oxides in the precursor glass compositions described herein may result in glass-ceramic articles having an increased maximum central tension for a given ion exchange treatment as compared to a glass-ceramic article formed from a precursor glass composition that does not include alkaline earth oxides or transition metal oxides.

Moreover, FIGS. 3-5 indicate that a target central tension may be achieved more quickly by including certain alkaline earth oxides and/or transition metal oxides in the precursor glass compositions as described herein. For example, as shown in FIG. 3, the glass-ceramic article formed from precursor glass composition 5 achieved a central tension of 100 MPa after approximately 6 hours of ion exchange, whereas the other glass-ceramic articles took longer to achieve a central tension of 100 MPa. A target central tension is achieved more quickly because the alkaline earth oxide and/or transition metal oxide containing glass-ceramic articles produce more stress per ion exchanged, which shortens the required ion exchange time. Shorter ion exchange time reduces costs and has the benefit of lower stress relaxation that may be caused by elevated temperature exposure. Therefore, the precursor glass compositions described herein may be tailored to include certain alkaline earth oxides and/or transition metal oxides to achieve a target central tension in a relatively shorter period of time.

It will be apparent to those skilled in the art that various modifications and variations may be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. A glass-ceramic article comprising:
greater than or equal to 60 mol % and less than or equal to 72 mol % SiO₂;
greater than or equal to 2.5 mol % and less than or equal to 8 mol % Al₂O₃;
greater than or equal to 17 mol % and less than or equal to 26 mol % Li₂O;
greater than or equal to 0.2 mol % and less than or equal to 4 mol % ZrO₂; and
greater than or equal to 0.5 mol % and less than or equal to 2 mol % P₂O₅, wherein:
alkaline earth oxides+transition metal oxides is greater than or equal to 0.1 mol % and less than or equal to 6 mol %, wherein alkaline earth oxides is the sum of CaO, MgO, SrO, and BaO and transition metal oxides is the sum of La₂O₃, Y₂O₃, Ta₂O₅, and GeO₂;
P₂O₅+ZrO₂ is greater than or equal to 1 mol % and less than or equal to 6 mol %;
(SiO₂+Al₂O₃)/(P₂O₅+ZrO₂) is greater than or equal to 12 mol % and less than or equal to 34 mol %; and
the glass-ceramic article comprises a crystalline phase comprising lithium disilicate and petalite, wherein the total amount of lithium disilicate and petalite is greater than 50 wt %, based on a total weight of the crystalline phase.

2. The glass-ceramic article of claim 1, wherein the glass-ceramic article comprises greater than or equal to 0.5 mol % and less than or equal to 4 mol % ZrO₂.

3. The glass-ceramic article of claim 1, wherein alkaline earth oxides+transition metal oxides is greater than or equal to 0.1 mol % and less than or equal to 5 mol %.

4. The glass-ceramic article of claim 1, wherein P₂O₅+ZrO₂ is greater than or equal to 2 mol % and less than or equal to 5 mol %.

5. The glass-ceramic article of claim 1, wherein (SiO₂+Al₂O₃)/(P₂O₅+ZrO₂) is greater than or equal to 14 mol % and less than or equal to 32 mol %.

6. The glass-ceramic article of claim 1, wherein a molar ratio of Li₂O to Al₂O₃ is greater than or equal to 2 and less than or equal to 12.

7. The glass-ceramic article of claim 1, wherein a molar of Li₂O to SiO₂ is greater than or equal to 0.25 and less than or equal to 0.5.

8. The glass-ceramic article of claim 1, wherein an average transmittance of the glass-ceramic article is greater than or equal to 50% and less than or equal to 95% over the wavelength range of 400 nm to 800 nm as measured at an article thickness of 0.8 mm.

9. The glass-ceramic article of claim 1, wherein a K_{Ic} fracture toughness of the glass-ceramic article as measured by a double torsion method is greater than or equal to 1.0 MPa·m^{1/2}.

10. The glass-ceramic article of claim 1, wherein an elastic modulus of the glass-ceramic article is greater than or equal to 90 GPa.

11. A glass composition comprising:
greater than or equal to 60 mol % and less than or equal to 72 mol % SiO₂;
greater than or equal to 2.5 mol % and less than or equal to 8 mol % Al₂O₃;
greater than or equal to 17 mol % and less than or equal to 26 mol % Li₂O;
greater than or equal to 1.5 mol % and less than or equal to 4 mol % ZrO₂; and
greater than or equal to 0.5 mol % and less than or equal to 2 mol % P₂O₅, wherein:
alkaline earth oxides+transition metal oxides is greater than or equal to 0.1 mol % and less than or equal to 6 mol %, wherein alkaline earth oxides is the sum of CaO, MgO, SrO, and BaO and transition metal oxides is the sum of La₂O₃, Y₂O₃, Ta₂O₅, and GeO₂; and
P₂O₅+ZrO₂ is greater than or equal to 1 mol % and less than or equal to 6 mol %.

12. The glass composition of claim 11, wherein alkaline earth oxides+transitional metal oxides is greater than or equal to 0.1 mol % and less than or equal to 5 mol %.

13. The glass composition of claim 11, wherein P₂O₅+ZrO₂ is greater than or equal to 2 mol % and less than or equal to 5 mol %.

14. A method of forming a glass-ceramic article, the method comprising:
heating a precursor glass article in an oven at a rate greater than or equal to 1° C./min and less than or equal to 10° C./min to a nucleation temperature, wherein the precursor glass article comprises a glass composition comprising:
greater than or equal to 60 mol % and less than or equal to 72 mol % SiO₂;
greater than or equal to 2.5 mol % and less than or equal to 8 mol % Al₂O₃;
greater than or equal to 17 mol % and less than or equal to 26 mol % Li₂O;
greater than or equal to 0.5 mol % and less than or equal to 4 mol % ZrO₂; and
greater than or equal to 0.5 mol % and less than or equal to 2 mol % P₂O₅, wherein:
alkaline earth oxides+transition metal oxides is greater than or equal to 0.1 mol % and less than or equal to 6 mol %, wherein alkaline earth oxides is the sum of CaO, MgO, SrO, and BaO and transition metal oxides is the sum of La₂O₃, Y₂O₃, Ta₂O₅, and GeO₂;
P₂O₅+ZrO₂ is greater than or equal to 1 mol % and less than or equal to 6 mol %; and
(SiO₂+Al₂O₃)/(P₂O₅+ZrO₂) is greater than or equal to 12 mol % and less than or equal to 34 mol %;
maintaining the precursor glass article at the nucleation temperature in the oven for time greater than or equal to 0.1 hour and less than or equal to 8 hours to produce a nucleated crystallizable glass article;
heating the nucleated crystallizable glass article in the oven at a rate greater than or equal to 1° C./min and less than or equal to 10° C./min to a crystallization temperature;
maintaining the nucleated crystallizable glass article at the crystallization temperature in the oven for a time greater than or equal to 0.1 hour and less than or equal to 8 hours to produce the glass-ceramic article, wherein the glass-ceramic article comprises a crystalline phase comprising lithium disilicate and petalite, wherein the total amount of lithium disilicate and petalite is greater than 50 wt %, based on a total weight of the crystalline phase; and
cooling the glass-ceramic article to room temperature.

15. The method of claim 14, further comprising strengthening the glass-ceramic article in an ion exchange bath at a temperature greater than or equal to 350° C. to less than or equal to 500° C. for a time period greater than or equal to 2 hours to less than or equal to 12 hours to form an ion exchanged glass-ceramic article.

16. The method of claim 15, wherein the glass-ceramic article has a maximum central tension greater than or equal to 30 MPa.

17. The method of claim 15, wherein the glass-ceramic article has a surface compressive stress greater than or equal to 80 MPa.

18. The method of claim 15, wherein the glass-ceramic article has a depth of compression greater than or equal to 0.025 t.

19. The method of claim 15, wherein the glass-ceramic article has a depth of sodium ion penetration greater than or equal to 0.025 t and less than or equal to 0.28 t.

20. The method of claim 15, wherein the glass-ceramic article has a depth of potassium ion penetration greater than or equal to 0 t and less than or equal to 0.01 t.
